(19) United States
(12) Patent Application Publication
(10) Pub. No.: US 2012/0159112 A1
(43) Pub. Date: Jun. 21, 2012

(54) COMPUTER SYSTEM MANAGEMENT APPARATUS AND MANAGEMENT METHOD

(75) Inventors: Yoshitaka Tokusho, Tokyo (JP); Takato Kusama, Yokohama (JP); Yuuki Miyamoto, Yokohama (JP)

(73) Assignee: Hitachi, Ltd.

(21) Appl. No.: 13/062,170

(22) PCT Filed: Dec. 15, 2010
(86) PCT No.: PCT/JP2010/072514

§ 371 Date: Mar. 3, 2011

(51) Int. Cl. G06F 12/02

(52) U.S. Cl. 711/171; 711/E12.002

(57) ABSTRACT

The present invention makes it possible for different types of application programs to efficiently use a virtual volume created on a basis of a hierarchized pool. A configuration management part P30 determines, based on access information, to which of storage tiers 211 actual areas 212 allocated to virtual volumes 220 should be allocated. The configuration management part comprises a determination part P3020 for determining a type of an application program that uses an actual area, and reallocation destination instruction parts P3021 and P3022 for determining reallocation destinations of the actual areas in accordance with the determination result, and instructing the storage apparatus as to these determinations.

### TECHNICAL FIELD

The present invention relates to a computer system management apparatus and management method.

### BACKGROUND ART

Storage virtualization technology, which creates a tiered pool using multiple types of storage devices of respectively different performance, and allocates an actual storage area (also called an actual area), which is stored in this tiered pool, to a virtual logical volume (a virtual volume) in accordance with a write access from a host computer, is known.

In one prior art, a virtual storage area of the virtual volume is partitioned into multiple partial areas (hereinafter called “virtual areas”). In this prior art, selection is made as to allocation of a certain actual area of certain storage devices belonging to certain tiers in virtual area units (Patent Literature 1). A storage apparatus regularly switches the storage device that constitutes the page reallocation destination in accordance with the number of I/Os (Input/Output) of each page that has been allocated. For example, a page with a large number of I/Os is allocated to a high-performance storage device, and a page with a small number of I/Os is allocated to a low-performance storage apparatus.

### CITATION LIST

### Patent Literature

### PTL 1

US Patent Application Publication No. 2007/0055713

### SUMMARY OF INVENTION

### Technical Problem

In the prior art, a suitable storage device for storing data is selected based on the access history of this data, and the data is simply migrated to this selected storage device with no consideration being given to the relationship between multiple application programs. Therefore, the following problem occurs in a storage apparatus that is able to simultaneously use multiple different virtual volumes.

A user-requested performance (SLA: Service Alliance Level) is configured for one application program, and this one application program uses one virtual volume. Another application program uses another virtual volume. Under these circumstances, when the other application program temporarily makes frequent use of the other virtual volume, for example, an actual area belonging to a high-performance tier is allocated to a virtual area of the other virtual volume even though this usage is temporary.

The total size of the high-performance actual area allocated to the one virtual volume decreases in proportion to the high-performance actual area being used by the other virtual volume. Therefore, the average response time of the one virtual volume is likely to drop, making it impossible to satisfy the SLA.

The SLA, for example, is an operating condition with respect to an application program. In a case where an SLA is configured for an application program, for example, an actual area is allocated from a tier that is appropriate for the access status to the virtual area used by the application program.

Another problem of the prior art will be explained. For example, it is supposed that a time limit is configured with respect to the other application program, making it necessary to complete processing within a prescribed period of time. It is supposed that the frequency with which the other application program uses the other virtual volume is less than the frequency with which the one application program uses the one virtual volume. In accordance with this, an actual area belonging to the high-performance tier is allocated more often to the one virtual volume for which the access frequency is high. Not enough actual areas belonging to the high-performance tier are allocated to the other virtual volume for which the access frequency is low. Therefore, the average response time of the other virtual volume is likely to drop, and the other application program, which uses the other virtual volume, may not complete processing within the prescribed time period that has been stipulated.

With the foregoing problems in mind, an object of the present invention is to provide a computer system management apparatus and management method, which take different types of application programs into account and make it possible to control the configuration of the virtual volume. Other objects of the present invention should become clear from the description of the embodiment, which will be explained below.

### Solution to Problem

To solve for the above-mentioned problems, a computer system management apparatus related to the present invention manages a computer system, which comprises multiple host computers that run application programs and a storage apparatus that provides a virtual volume to the host computers, wherein the storage apparatus comprises multiple pools comprising multiple storage tiers of respectively different performance, and is configured so as to select an actual storage area from each of the storage tiers in accordance with a write access from each of the host computers, and to allocate this selected actual storage area to an access-target virtual area inside the write-accessed virtual volume from among the respective virtual volumes, and the computer system management apparatus includes an allocation control part for deciding, based on access information, to which of the storage tiers the actual storage areas allocated to the virtual volumes should be allocated.

The allocation control part provided in the management apparatus comprises a determination part for determining a type of an application program that uses the actual storage area allocated to the virtual area from among the actual storage areas inside the pool, and a reallocation destination instruction part for determining a reallocation destination of the actual storage area in accordance with the determination result by the determination part, and instructing the storage apparatus as to the determined reallocation destination.

The management apparatus may further include: a microprocessor; a memory for storing a prescribed computer program that is executed by the microprocessor; and a communication interface circuit for the microprocessor to communicate with the host computer and the storage apparatus. In accordance with this, the allocation control part is realized by the microprocessor executing the prescribed computer program.

The determination part determines whether or not the type of the application program that uses the actual storage area is a first application program, which is a high-priority transaction process, and the reallocation destination instruction part can determine a reallocation destination for a first actual storage area such that the first actual storage area, which is used by the first application program from among the actual storage areas inside the pool, is preferentially allocated to a relatively high-performance storage tier of the storage tiers, and instructs the storage apparatus as to the determined reallocation destination.

The determination part can also determine whether the type of the application program that uses the actual storage area is a first application program, which is a high-priority transaction process, or a second application program, which is a batch process that has a time limit. The reallocation destination instruction part can initially determine a reallocation destination of the first actual storage area such that the first actual storage area used by the first application program is preferentially allocated to the relatively high-performance storage tier, and thereafter, determine a reallocation destination of a second actual storage area used by the second application program from among the actual storage areas inside the pool, and can instruct the storage apparatus as to the determined first actual storage area reallocation destination and the determined second actual storage area reallocation destination.

The determination part can acquire from a user, via a user interface part, application type information denoting whether the application programs running on the host computers are for transaction processes or for batch processes. In addition, the determination part can acquire from the storage apparatus access information denoting an access frequency with which each of the application programs uses each of the actual storage areas.

In addition, first access information, which denotes an access frequency with which the first application program uses the actual storage area, may be acquired during a period of time that the second application program is executed. That is, while the second application program is being executed, it is also possible to detect the utilization status of the actual storage area in accordance with the first application program.

The present invention can also be understood as a management method for managing the computer system. In addition, at least one part of the present invention may be configured as a computer program. Furthermore, multiple characteristic features of the present invention, which will be described in the examples, can be combined at will.

### BRIEF DESCRIPTION OF DRAWINGS

FIG. 1 is a schematic diagram showing an overview of the embodiment as a whole.

FIG. 2 is a block diagram of an entire computer system.

FIG. 3 is a block diagram of a host computer.

FIG. 4 is a block diagram of a storage apparatus.

FIG. 5 is an example of the configuration of information for the storage apparatus to manage a RAID group.

FIG. 6 is an example of the configuration of information for the storage apparatus to manage an actual area.

FIG. 7 is an example of the configuration of information for the storage apparatus to manage a virtual volume.

FIG. 8 is a block diagram of a management server.

FIG. 9 is an example of the configuration of information for the management server to manage a RAID group.

FIG. 10 is an example of the configuration of information for the management server to manage a virtual volume.

FIG. 11 is an example of the configuration of information for the management server to manage a storage tier.

FIG. 12 is an example of the configuration of information to be defined with respect to an application program.

FIG. 13 (a) shows an example of the configuration of information defined with respect to a batch process, and FIG. 13 (b) shows an example of the configuration of information for managing the corresponding relationship between a host computer and a virtual volume.

FIG. 14 is a flowchart showing the processing for registering definition information in the management server.

FIG. 15 is an example of a screen for inputting application definition information.

FIG. 16 is an example of a screen for inputting batch process definition information.

FIG. 17 is an example of a screen for configuring a condition for disposing data in a tier.

FIG. 18 is a flowchart showing the processing for acquiring performance information.

FIG. 19 is a flowchart showing the processing for reallocating data.

FIG. 20 is a flowchart showing the processing for reallocating data to be used in accordance with a high-priority transaction process.

FIG. 21 is a flowchart showing the processing for reallocating data to be used in accordance with a time-limited batch process.

FIG. 22 is a flowchart showing a read process.

FIG. 23 is a flowchart showing a write process.

FIG. 24 shows an example related to a second example of the configuration of information for the storage apparatus to manage a virtual volume.

FIG. 25 is an example of the configuration of information for the management server to manage a virtual volume.

FIG. 26 is an example of the configuration of information for managing a storage tier.

FIG. 27 is an example of the configuration of batch process definition information.

FIG. 28 is a flowchart showing the processing for acquiring performance information.

FIG. 29 is a flowchart showing the processing for reallocating data.

FIG. 30 is a flowchart showing the processing for estimating the time required for batch processing.

FIG. 31 is a flowchart showing reallocation processing.

FIG. 32 is an example of a screen for notifying a user that batch processing will not be complete within a prescribed time period.

FIG. 33 is a flowchart related to a third example showing the processing for estimating the time required for batch processing.

FIG. 34 is an example of a screen for configuring a threshold for computing the surplus time that will occur in a batch process time period.

FIG. 35 is an example related to a fourth example of the configuration of information for the management server to manage a virtual volume.

FIG. 36 is a flowchart showing the processing for acquiring performance information.

FIG. 37 is an example of a screen for configuring an access history retention period.

FIG. 38 is a flowchart related to a fifth example showing the processing for registering definition information.

FIG. 39 is an example of a screen related to a sixth example showing the utilization status in accordance with the respective application programs for each storage tier.

FIG. 40 is a flowchart related to a seventh example showing the processing for determining a threshold for stipulating the boundaries between the respective storage tiers.

FIG. 41 is a diagram related to an eighth example schematically showing the configuration of a computer system.

FIG. 42 is an example of the configuration of information for managing the runtime history of a transaction process.

FIG. 43 is an example of the configuration of information for defining a batch process.

FIG. 44 is a flowchart showing the processing for estimating the runtime of a transaction process.

FIG. 45 is an example of a screen related to a ninth example for preconfiguring a storage tier to be preferentially allocated to a batch process.

### DESCRIPTION OF EMBODIMENTS

An embodiment of the present invention will be explained below based on the drawings. In this embodiment, as will be described hereinbelow, a reallocation destination for data used by an application program is decided in accordance with the type of this application program.

Furthermore, in the explanation that follows, various types of information used in this embodiment will be explained using the expression “aaa table”. However, the various information need not be expressed using a table format, but rather, may be expressed using a list, a database, a queue, or another such data structure instead. Therefore, to show that the various information is not dependent on the data structure, in this embodiment “aaa table”, “aaa list”, “aaa DB”, and “aaa queue” may be called “aaa information”.

Furthermore, when explaining the content of various information, an expression such as “identification information”, “identifier”, “name”, and “ID” can be used, but these expressions are mutually interchangeable.

In addition, in the explanation that follows, an operation may be explained giving a “program” as the subject. A computer program is executed by a microprocessor. The computer program executes a prescribed process using a memory and a communication port (a communication control apparatus). Therefore, the content of a flowchart can be explained using the microprocessor as the subject.

In addition, processing carried out by the computer program can also be explained using a management server or other such computer as the subject. Furthermore, either part or all of a computer program may be realized using a dedicated hardware circuit. Also, the computer program may be modularized. In addition, various types of computer programs can be installed in a computer in accordance with either a program delivery server or a storage medium.

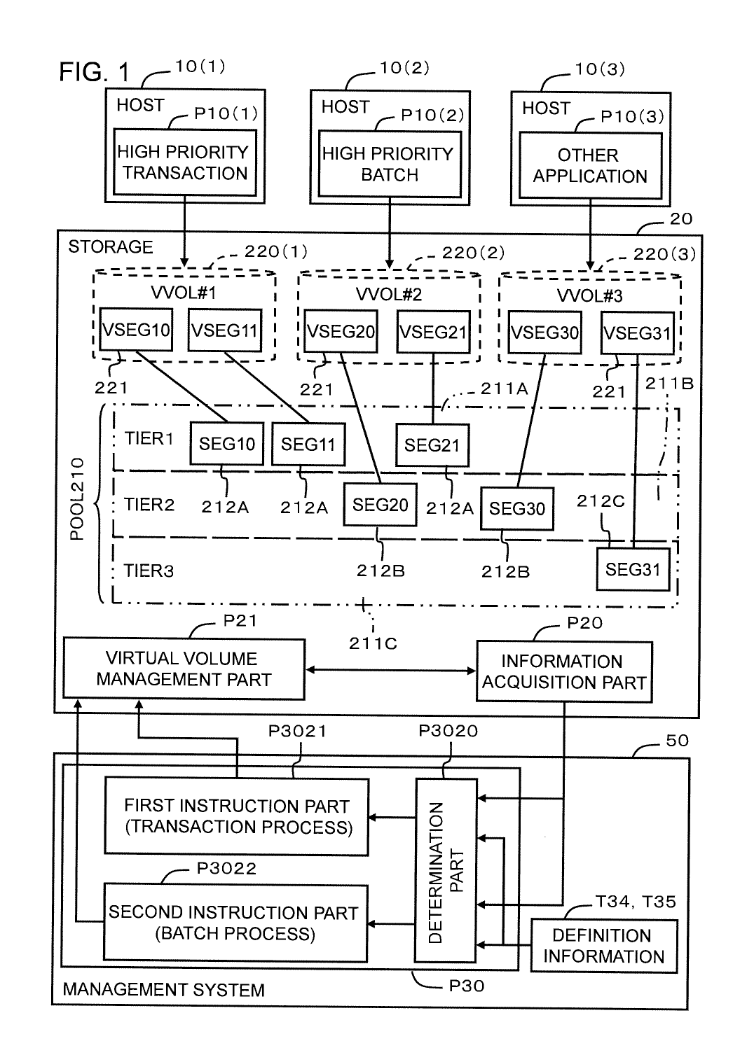

FIG. 1 is a diagram for explaining an overview of the embodiment, but the scope of the present invention is not limited to the configuration described in FIG. 1. The computer system, for example, comprises multiple host computers (hereinafter hosts) 10, at least one storage apparatus 20, and one management system 50 as a “management apparatus”.

The hosts 10 (1), 10 (2) and 10 (3), for example, comprise computers like a server computer or a mainframe. When no particular distinction is made, hosts 10 (1), 10 (2) and 10 (3) will be called host 10.

Each host 10 comprises an application program P10. A first application program P10 (1) carries out a transaction process. A high priority is preconfigured for the first application program P10 by the user.

A second application program P10 (2) carries out a batch process. A time limit is configured with respect to the second application program P10 (2). Time limit signifies that the time required to complete a batch process is determined in advance. In FIG. 1, a time-limited batch process is shown as a “high-priority batch process”. A batch process for which a limit has been placed on the completion time can be considered to be a high-priority batch process.

A third application program P10 (3) is another application program, which does not correspond to either the first application program P10 (1) or the second application program P10 (2). Therefore, the third application program P10 (3), for example, comprises a low-priority transaction process and a batch process that lacks a time limit. Hereinafter, when no particular distinction is made, the application programs P10 (1), P10 (2) and P10 (3) will be called the application program P10.

The storage apparatus 20 provides the host 10 with a logical volume 220 that has been created virtually. Hereinafter, the virtual logical volume 220 will be called the virtual volume 220. In the drawings, the virtual volume 220 is shown as “VVOL”.

The host 10 (1) can use a virtual volume 220 (1), the host 10 (2) can use a virtual volume 220 (2), and the host 10 (3) can use a virtual volume 220 (3). The host 10 is not able to use a virtual volume other than the virtual volume that has been allocated to itself. Hereinafter, when no particular distinction is made, the virtual volumes 220 (1), 220 (2) and 220 (3) will be called the virtual volume 220.

The virtual volume 220 is defined only by the volume size and access method thereof, and does not comprise an actual area for storing data.

Each virtual volume 220 is associated with a pool 210. Briefly stated, in a case where data is written from the host 10 to a virtual area (VSEG) 221 in the virtual volume 220, an actual area (SEG) 212 selected from the pool 210 is allocated to the virtual volume 220. The data from the host 10 is written to the actual area 212 that has been allocated.

The pool 210 comprises multiple storage tiers having respectively different performance. The pool 210, for example, can comprise three storage tiers, i.e., a first tier 211A, a second tier 211B, and a third tier 211C.

The first tier 211A comprises multiple actual areas 212A of the highest performance storage device. The first tier 211A can also be called a high-level tier. The second tier 211B comprises multiple actual areas 2123 of a medium performance storage device. The second tier 2113 can also be called a mid-level tier. The third tier 211C comprises multiple actual areas 212C of a low-performance storage device. The third tier 211C can also be called a low-level tier. When no particular distinction is made, the actual areas 212A, 212B and 212C will be called the actual area 212. Similarly, the tiers 211A, 211B and 211C will be called the tier 211.

In a case where the host 10 writes data to an unallocated virtual area 221 in the virtual volume 220, an actual area 212, which belongs to any one of the tiers 211A, 211B and 211C in the pool 210, is selected. The selected actual area 212 is allocated to the write-target virtual area VSEG. Write data from the host 10 is written to this actual area SEG 212.

The first application program P10 (1), which is a high-priority transaction process, uses the first virtual volume 220 (1) here. An actual area 212A belonging to the high-performance tier 211A is allocated to the virtual area 221 of the first virtual volume 220 (1).

The second application program P10 (2), which is a time-limited batch process, uses the second virtual volume 220 (2). An actual area 212A belonging to the high-performance tier 211A and an actual area 212B belonging to the medium-performance tier 211B are allocated to the virtual area 221 of the second virtual volume 220 (2).

The other application program P10 (3) uses the third virtual volume 220 (3). An actual area 212B belonging to the medium-performance tier 212B and an actual area 212C belonging to the low-performance tier 211C are allocated to the virtual area 221 of the third virtual volume 220 (3).

The tier to which the actual area 212 allocated to the virtual volume 220 belongs is changed either regularly or irregularly based on information related to access to this actual area 212 (in other words, information related to access to the virtual area 221).

For example, data of a high access frequency virtual area 221 is migrated to a higher performance tier. Alternatively, data of a low access frequency virtual area 221 is migrated to a lower performance tier. In accordance with this, the response time of the high access frequency data is shortened. In addition, since low access frequency data can be migrated from a high-performance tier to the low-performance tier, it is possible to make efficient use of the high-performance tier.

In addition to the pool 210 and the virtual volume 220, the storage apparatus 20 also comprises an information acquisition part P20 and a virtual volume management part P21. The virtual volume management part P21 is a function for managing the configuration of the virtual volume 220. For example, the virtual volume management part P21 creates a virtual volume 220, associates this virtual volume 220 with the host 10, and allocates an actual area 212 in the pool 210 to the virtual area 221 in accordance with a write access from the host 10. In addition, the virtual volume management part P21 changes the reallocation destination of this data based on an instruction from the management system 50 and/or a data access frequency.

The information acquisition part P20 acquires a performance value of each actual area 212 of each tier 211. As used here, for example, “performance” is access performance. Access performance includes a response time, a data transfer rate, and an IOPS (number of processed access requests per unit of time).

The management system 50 comprises a configuration management part P30 that serves as the “allocation control part”, application definition information T34 and batch process definition information T35. The definition information T34 and T35 will be described in detail further below. Briefly stated, the application definition information T34 defines the type and priority of the application program P10. The batch process definition information T35 defines the time window during which batch processing is to be executed. The time window is defined in accordance with the batch process start-time and the batch process end-time.

The configuration management part P30, for example, comprises a determination part P3020, a first instruction part P3021, and a second instruction part P3022.

The determination part P3020, for example, determines whether a data reallocation-target application program is a prescribed first application program P10 (1) or a prescribed second application program P10 (2) based on the definition information T34 and T35 and performance information received from the information acquisition part P20.

As described hereinabove, the prescribed first application program P10 (1), for example, is a transaction process that is configured as a high priority. The prescribed second application program P10 (2) is a batch process for which a time limit has been configured.

The first instruction part P3021, which comprises one part of the “reallocation destination instruction part”, first determines the reallocation destinations of the actual areas 212 (SEG10, SEG11) to be used in accordance with the first application program P10 (1) so that these actual areas are allocated to the relatively high-performance tier 211A, and instructs the storage apparatus 20 of this determination.

The second instruction part P3022 together with the first instruction part P3021 configures the “reallocation destination instruction part”. The second instruction part P3022, subsequent to the reallocation destination determination having been completed by the first instruction part P3021, determines the reallocation destination of the actual areas 212 (SEG 20, SEG 21) to be used by the second application program P10 (2) and instructs the storage apparatus 20 of this determination.

The data of the virtual volume 220 (3) being used by the other application program P10 (3) is allocated to the tier corresponding to the access frequency as is normal.

The revision (reallocation) of the correspondence between the virtual area and the actual area is carried out without suspending an I/O request from the host 10. The management system 50 revises the allocation of actual areas to each of the virtual areas of the respective virtual volumes, and instructs the storage apparatus 20 as to these revisions. In accordance with this, the management system 50 is able to determine the data reallocation destination for each virtual area while taking into account the ever-changing state of the storage apparatus without suspending the I/O requests of the host 10.

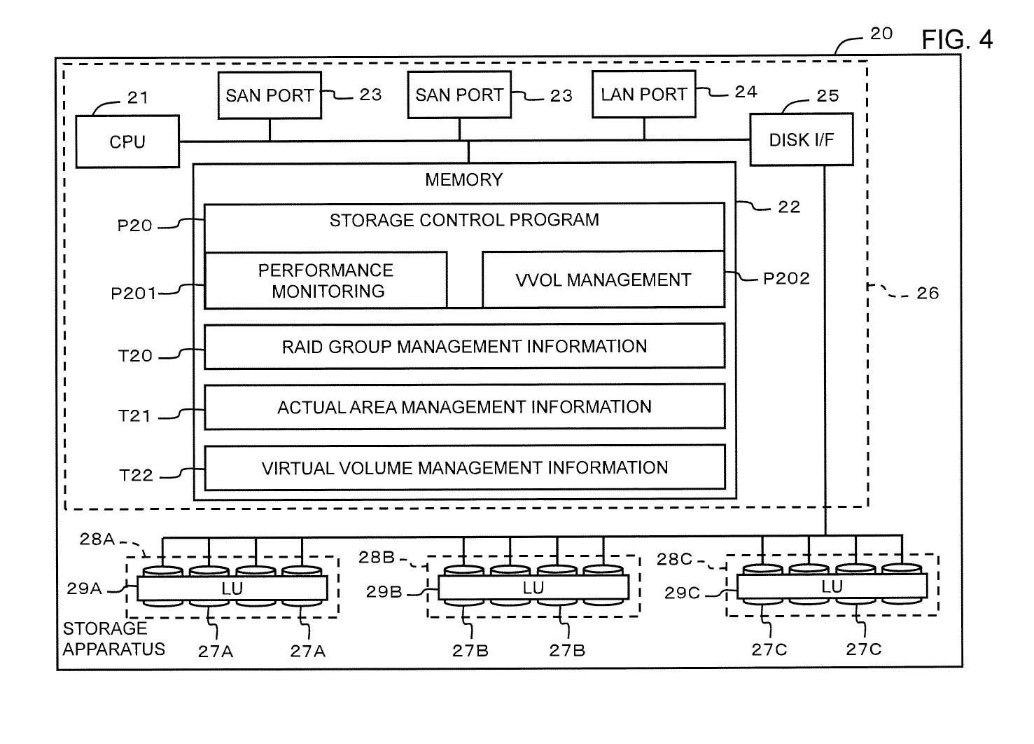

Furthermore, the functions of the management system 50 may be provided inside the storage apparatus 20. That is, the storage apparatus 20 controller 26 (refer to FIG. 4) may be configured to determine the data reallocation destination.

By configuring this embodiment like this, the tier to which virtual volume data is to be allocated is determined in accordance with the type of application program that is using the virtual volume. In this embodiment, first of all, the reallocation destination of data used by a high-priority transaction process P10 (1) is determined. Consequently, this data can be allocated to a relatively high-performance tier 212A. Since the data reallocation process is executed first, it is highly likely that a free area of the high-performance tier 211A can be used. In accordance with this, the average response time of the virtual volume 220 (1) used in accordance with the high-priority transaction process P10 (1) can be speeded up, making it possible to satisfy the SLA configured with respect to the transaction process P10 (1).

In this embodiment, the reallocation destination of data used in accordance with a time-limited batch process P10 (2) is determined after the reallocation destination of data used in accordance with the high-priority transaction process P10 (1) has been determined. Consequently, the data used in accordance with the time-limited batch process P10 (2) can be allocated to the relatively high-performance tier 211A and/or the medium-performance tier 211B. Since the reallocation destination of the data used in accordance with the time-limited batch process P10 (2) is determined relatively quickly, it is possible to allocate this data to the high-performance tier 211A and/or the medium-performance tier 211B. In accordance with this, the batch process for which the time limit has been configured is able to end within the configured time period.

### Example 1

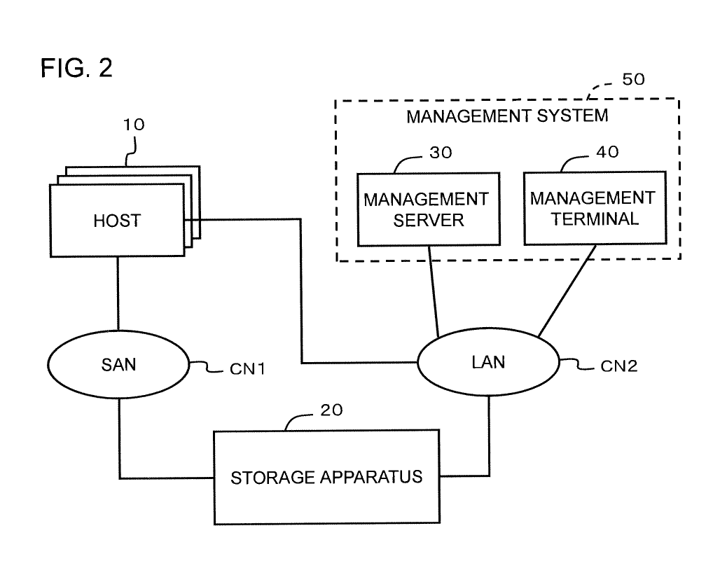

FIG. 2 is a schematic diagram showing the configuration of an entire computer system. The computer system shown in FIG. 2, for example, comprises multiple hosts 10, at least one storage apparatus 20, and one management system 50.

The management system 50 comprises a management server 30 and a management terminal 40. The management terminal 40, for example, comprises a personal computer, a personal digital assistant, or a mobile telephone. The user logs in to the management server 30 via the management terminal 40, and carries out the registration of the definition information T34 and T35. Furthermore, multiple management terminals 40 may be provided. The configuration may be such that the management terminal 40 is eliminated and an input/output device coupled to the management server 30 is used.

The hosts 10 and the storage apparatus 20 are coupled by way of a communication network CN1 like a FC-SAN (Fibre Channel-Storage Area Network) or an IP-SAN (Internet Protocol-SAN). The host 10, the storage apparatus 20, the management server 30 and the management terminal 40 are coupled by way of a communication network CN2 like a LAN (Local Area network).

The first communication network CN1 can be called the data input/output network. The second communication network CN2 can be called the management network. The respective communication networks CN1, CN2 may be integrated into a single network.

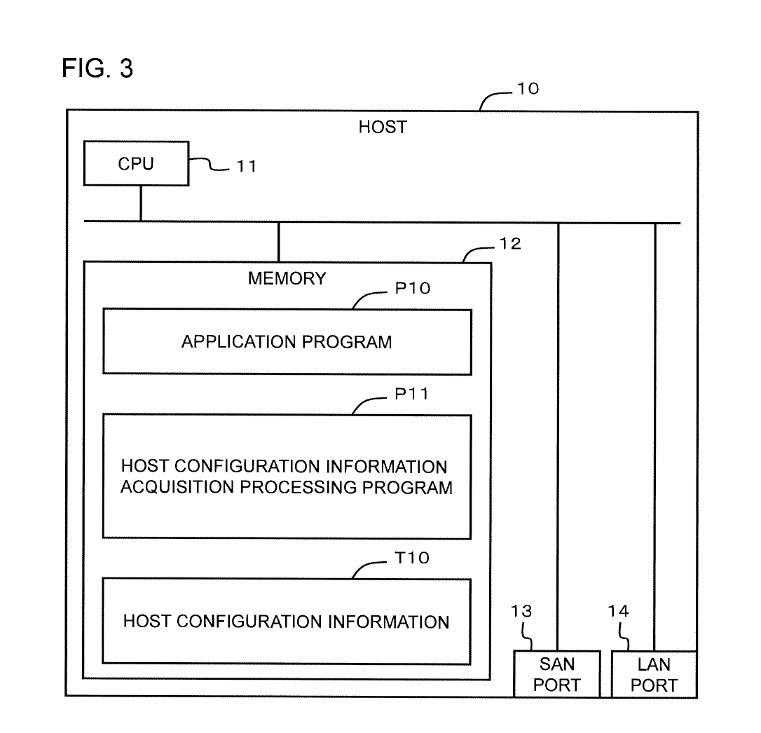

FIG. 3 shows the hardware configuration of the host 10. The host 10, for example, comprises a microprocessor (hereinafter the CPU) 11, a memory 12, a SAN port 13, and a LAN port 14. These components 11, 12, 13 and 14 are interconnected via an internal bus.

The memory 12, for example, stores an application program P10, a host configuration information acquisition processing program P11, and host configuration information T10. The application program P10 type, for example, can be a transaction process or a batch process.

The host configuration information acquisition processing program P11 is for acquiring the host configuration information T10. The host configuration information acquisition processing program P11 queries the storage apparatus 20 via either the data input/output network CN1 or the management network CN2 regarding the identification information of all of the virtual volumes 220 used by the host 10. Based on the information acquired from the storage apparatus 20, the host configuration information acquisition processing program P11 creates the host configuration information T10.

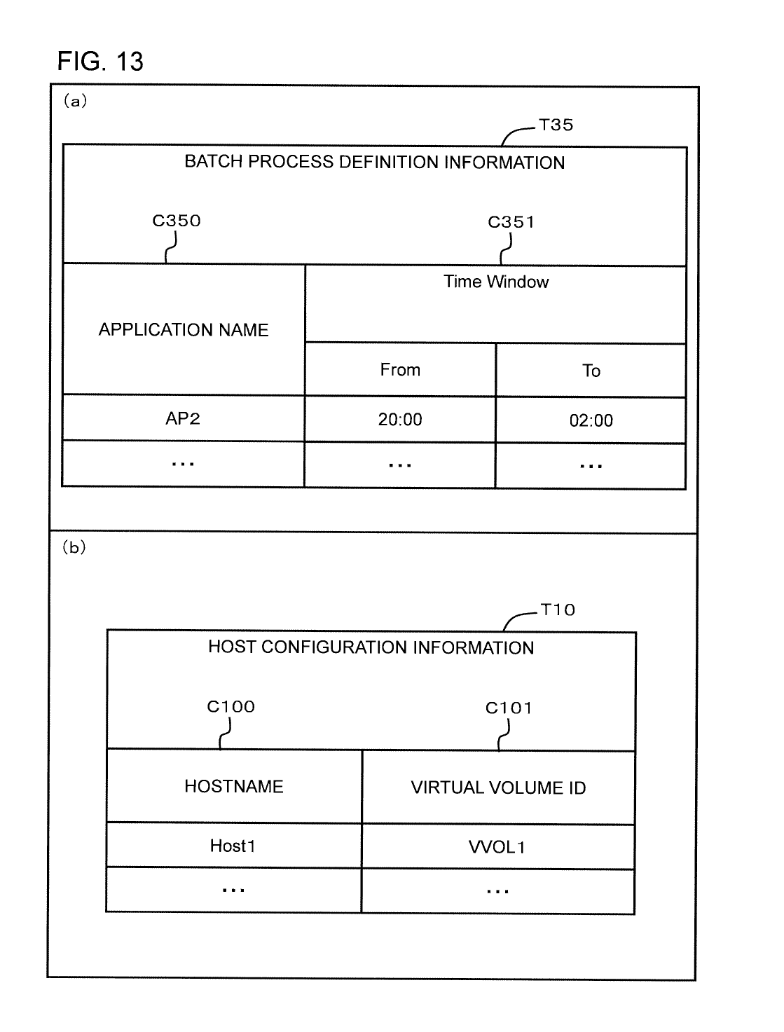

The host configuration information T10 is for managing a corresponding relationship between the host 10 and the virtual volume 220. The host configuration information T10 will be explained in detail further below using FIG. 13 (b).

The SAN port 13 is a circuit for carrying out two-way communications over the first communication network CN1. The LAN port 14 is a circuit for carrying out two-way communications over the second communication network CN2.

FIG. 4 is the hardware configuration of the storage apparatus 20. The storage apparatus 20 comprises a controller 26 and multiple physical storage devices of different performance 27A, 27B and 270. The controller 26 and the respective storage devices 27A, 27B, 27C are interconnected via an internal bus. When no particular distinction is made, the storage devices 27A, 27B and 27C will be called the storage device 27.

For example, a hard disk device, a semiconductor memory device, an optical disk device, a magneto-optical disk device, a magnetic tape device, a flexible disk device, and other such devices that are able to read and write data can be used as the storage device 27.

In a case where a hard disk device is used as the storage device, for example, a FC (Fibre Channel) disk, a SCSI (Small Computer System Interface) disk, a SATA disk, an ATA (AT Attachment) disk, and a SAS (Serial Attached SCSI) disk can be used. Furthermore, for example, it is also possible to use a storage device such as a flash memory, a FeRAM (Ferroelectric Random Access Memory), a MRAM (Magnetoresistive Random Access Memory), an Ovonic Unified Memory, and a RRAM (Resistance RAM). In addition, for example, the configuration may also be such that different types of storage devices, like a flash memory device and a hard disk drive, are intermixed.

In this example, explanation may be given using an SSD (a flash memory device) as an example of the relatively high-performance storage device 27A, an SAS disk as an example of the medium-performance storage device 27B, and a SATA disk as an example of the relatively low-performance storage device 27C.

RAID groups 28A, 28B and 28C are created by grouping together storage devices 27A, 27B and 27C of the same type. The RAID group 28A comprises physical storage areas of multiple high-performance storage devices 27A. The RAID group 28B comprises physical storage areas of multiple medium-performance storage devices 27B. The RAID group 28C comprises physical storage areas of multiple low-performance storage devices 27C. When no particular distinction is made, the RAID groups 28A, 28B and 28C will be called the RAID group 28.

Logical volumes 29A, 29B and 29C can be provided by segmenting the physical storage areas of the respective RAID groups 28A, 28B and 28C into either fixed sizes or variable sizes. The logical volume 29A is provided with respect to the high-performance RAID group 28A. The logical volume 29B is provided with respect to the medium-performance RAID group 28B. The logical volume 29C is provided with respect to the low-performance RAID group 28C. Consequently, the logical volume 29A is a high-performance logical storage device, the logical volume 29B is a medium-performance logical storage device, and the logical volume 29C is a low-performance logical storage device. When no particular distinction is made, the logical volumes 29A, 29B and 29C will be called the logical volume 29.

The controller 26, for example, comprises a microprocessor 21, a memory 22, a SAN port 23, a LAN port 24, and a disk interface circuit 25.

The memory 22, for example, stores a storage control program P20, RAID group management information T20, actual area management information T21, and virtual volume management information T22.

The storage control program P20 comprises a performance monitoring processing program P201 and a virtual volume management program P202 as subprograms. The storage control program P20, in accordance with being executed by the microprocessor 21, carries out storage device 27 access control processing, performance monitoring processing, and virtual volume management processing.

The performance monitoring processing program P201 collects performance values with respect to the virtual volume 220. The performance monitoring processing program P201 totals how often each virtual volume 220 in the storage apparatus 20 is accessed, and records this access frequency in the virtual volume management information T22. The virtual volume access frequency, for example, is an aggregate of the number of times that the host 10 has accessed each virtual area in the virtual volume.

Furthermore, the “number of virtual area accesses” refers to the number of access requests for which processing was completed (or may also include access requests in the process of being processed) from among the access requests that specify either all or a portion of a target virtual area as an address range.

For example, in a case where an access request address range is either all or a portion of a certain virtual area (in other words, a virtual area includes the address range), the performance monitoring processing program P201 increases the number of pertinent virtual area accesses in proportion to the number of pertinent access requests. As another example, in a case where the access request address range comprises either all or a portion each of multiple virtual areas, the performance monitoring processing program P201 increases the number of accesses of the respective virtual areas in proportion to the number of pertinent access requests. Furthermore, in the case of a large size virtual area, the latter case does not occur very often. Consequently, the performance monitoring processing program P201 need only increase a count number of the virtual area, which includes the head of the address range specified by the access request.

The virtual volume management program P202, for example, revises the allocation of the actual area 212 to the virtual area 221 in the virtual volume 220 in accordance with an instruction from the management server 30. The process for revising the association between the virtual area 221 and the actual area 212 is called the reallocation process.

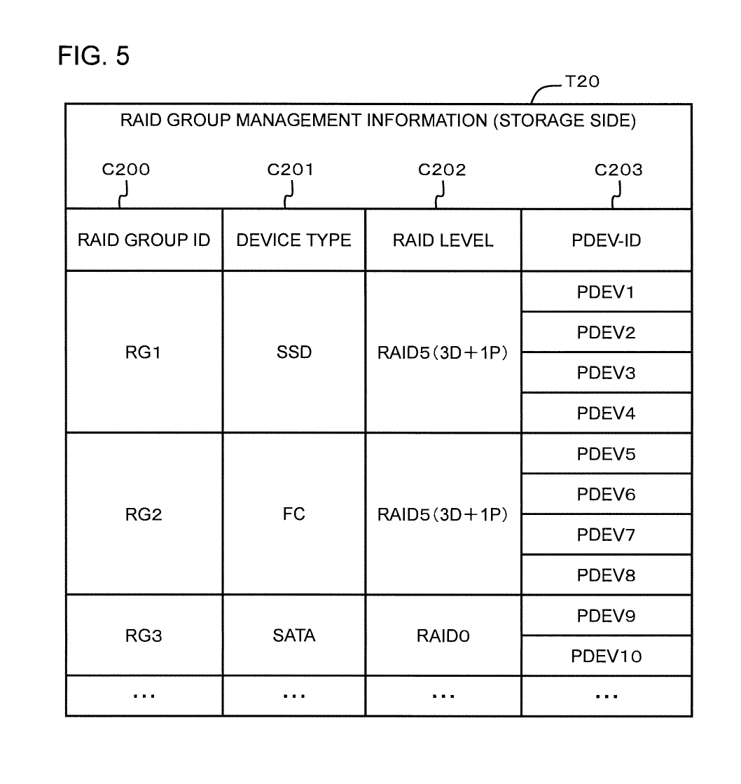

FIG. 5 shows an example of the configuration of the RAID group management information T20. The RAID group management information T20 manages the configuration of a RAID group 28.

The RAID group management information T20, for example, correspondingly manages a RAID group ID C200, a disk type C201, a RAID level C202, and a storage device ID C203. Furthermore, storage device may be abbreviated as “PDEV” in the drawings.

The RAID group ID C200 is information for identifying a RAID group 28. The disk type C201 is information denoting the type of storage device 27 comprising the RAID group 28. The RAID level C202 is information denoting a RAID level and combination of the RAID group 28. The storage device ID C203 is information for identifying a storage device 27 that comprises the RAID group 28.

Furthermore, the same holds true for the tables (information) described hereinbelow, but a portion of the items included in the table shown in the drawing may be changed to another item, or a new item may be added. In addition, a single table can also be divided into multiple tables.

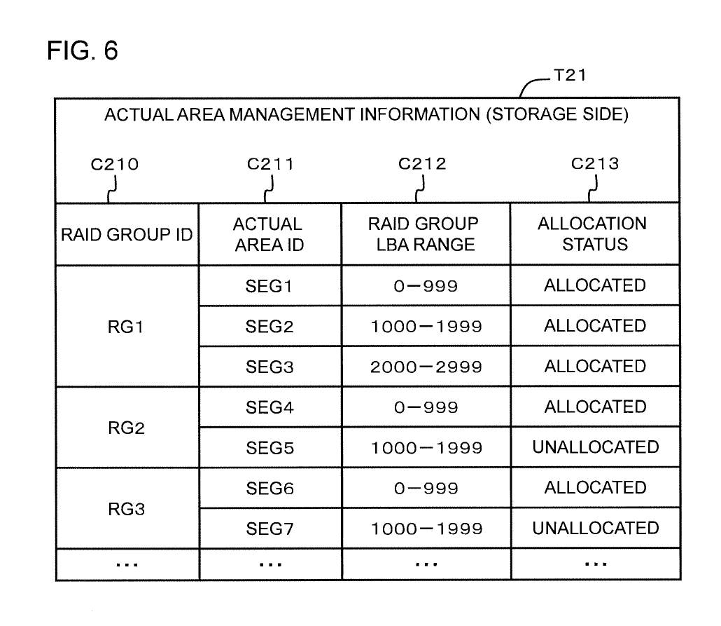

FIG. 6 shows an example of the configuration of the actual area management information T21. The actual area management information T21 manages information denoting whether or not a storage device 27 actual area 212 included in each RAID group 28 is allocated to a virtual volume 220.

The actual area management information T21 correspondingly manages a RAID group ID C210, an actual area ID C211, a RAID group LBA range C212, and an allocation status C213.

Identification information for identifying each RAID group 28 is registered in the RAID group ID C210. Identification information for identifying each actual area 212 is registered in the actual area ID C211. A value denoting the LBA range of the RAID group 28 corresponding to an actual area 212 is registered in the LBA range C212. Furthermore, LBA is the abbreviation for logical block access. A value denoting whether or not an actual area 212 is allocated to a virtual volume 220 is registered in the allocation status C213.

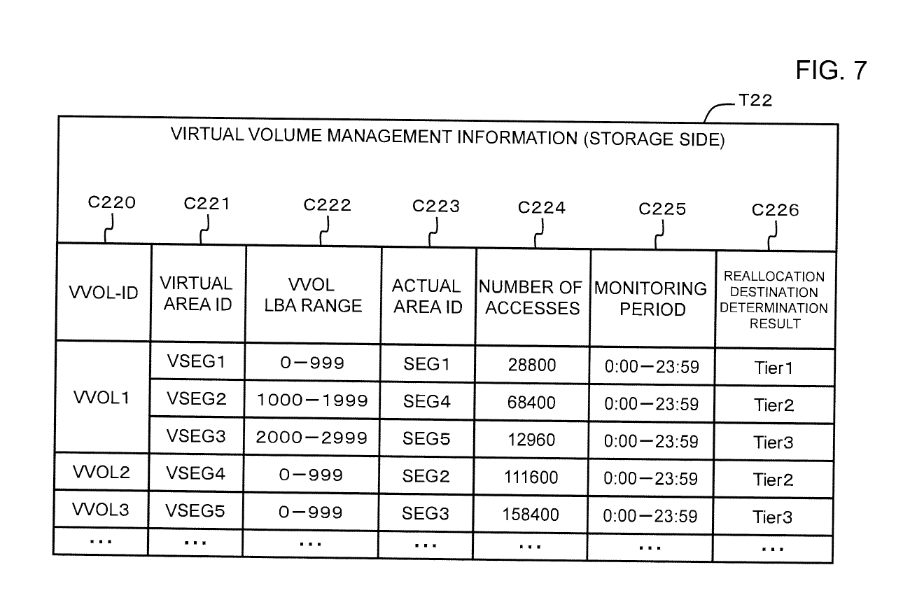

FIG. 7 shows an example of the configuration of the virtual volume management information T22. The virtual volume management information T22 manages information related to each virtual area in the virtual volume, and the actual area allocated to this virtual area.

For example, the virtual volume management information T22 correspondingly manages a virtual volume ID C220, a virtual area ID C221, a virtual volume LBA range C222, an actual area ID C223, a number of accesses C224, a monitoring period C225, and a reallocation destination determination result C226.

Information for identifying a virtual volume 220 is registered in the virtual volume ID (VVOL-ID) C220. The virtual volume ID C220 is not an identifier specified by the host 10, but rather is an identifier recognized inside the storage apparatus 20. Information for identifying a virtual area 221 is registered in the virtual area ID C221.

A value denoting a LBA range corresponding to a virtual area 221 in a virtual volume 220 is registered in the virtual volume LBA range C222. Information for identifying an actual area 212 that has been allocated to a virtual area 221 in a virtual volume 220 is registered in the actual area ID C223.

A value denoting the number of accesses (the cumulative number of I/Os) from the host 10 with respect to a virtual area 221 in a virtual volume 220 is registered in the number of accesses C224. The number of accesses C224 is a value denoting the number of times accessing has been carried out with respect to a virtual area. The monitoring of the number of accesses by the storage apparatus 20 is carried out within a time range configured in the monitoring period C225.

In a case where a value denoting a specific time window has not been configured in the monitoring period C225, the storage apparatus 20 carries out monitoring of the number of accesses at all times. The storage apparatus 20 resets the value of the number of accesses C224 to 0 when it starts monitoring. In a case where the result of monitoring during the monitoring period is not retained, the storage apparatus 20 resets the value of the number of accesses C224 to 0 after a fixed period of time, for example, every 24 hours.

A monitoring period in accordance with the performance monitoring processing program P201 is registered in the monitoring period C225. That is, a time range during which the performance monitoring processing program P201 monitors the number of times accessing is carried out to a virtual volume 220 and retains the monitoring result is stored in the C225. The monitoring period value can be applied in advance as a fixed value, or the management server 30 can configure an arbitrary value.

Information denoting a data reallocation destination tier determined in accordance with the reallocation process is registered in the reallocation destination determination result C226. In accordance with the reallocation process, which will be described further below, one tier, which will supply an actual area to be allocated to a virtual area in a virtual volume, is determined. Identification information for identifying the determined tier is stored in the reallocation destination determination result C226.

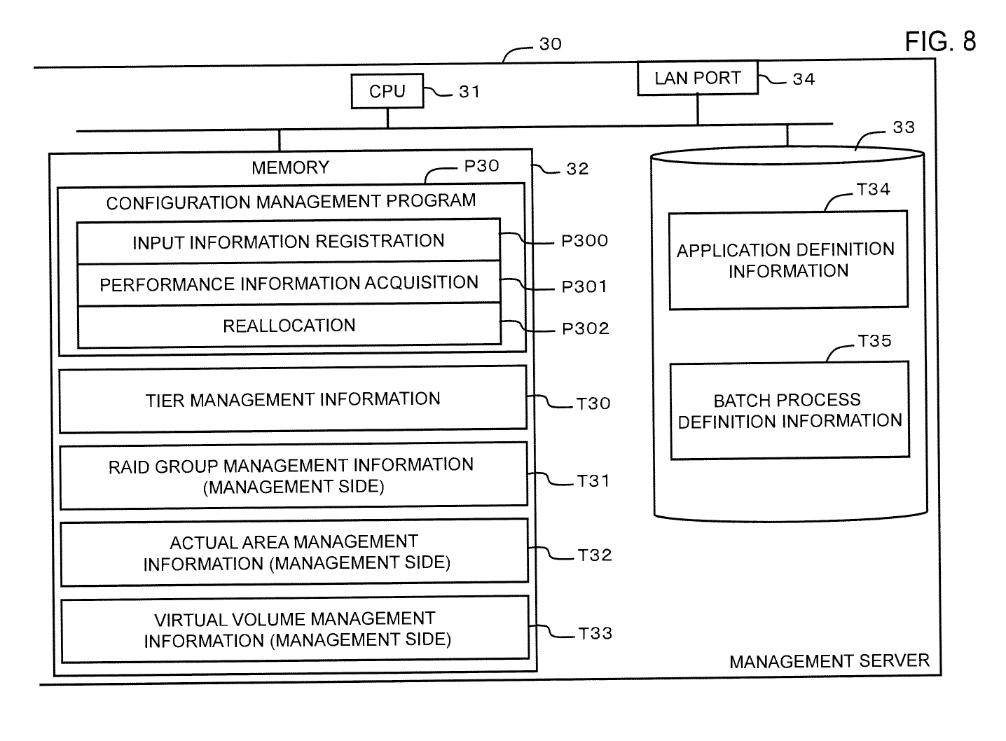

FIG. 8 shows an example of the configuration of the management server 30. The management server 30, for example, comprises a microprocessor 31, a memory 32, an auxiliary storage device 33, and a LAN port 34. The respective components 31, 32, 33 and 34 are interconnected via an internal bus.

The memory 32 stores a configuration management program P30, tier management information T30, RAID group management information T31, actual area management information T32, and virtual volume management information T33.

The configuration management program P30 comprises multiple subprograms. The multiple subprograms include an input information registration processing program P300, a performance information acquisition processing program P301, and a reallocation processing program P302.

The input information registration processing program P300, in accordance with a user input, acquires and stores application program P10 definition information, information constituting a condition for carrying out data reallocation between tiers, and batch process definition information.

The performance information acquisition processing program P301 acquires the number of accesses related to each virtual area from the storage apparatus 20, computes an average value of the number of accesses (number of I/Os) per unit of time, and stores this average value in the virtual volume management information T33. The unit for the average value of the number of accesses, for example, is IOPS (number of I/Os per second).

The reallocation processing program P302 determines the tier 211 to which virtual volume data is to be allocated based on the average value of the number of times accessing was carried out for each virtual area. The reallocation processing program P302 first of all reallocates the data of the virtual area used by the application program P10 (1), which is high priority, and, in addition, is a transaction process type application. Next, the reallocation processing program P302 reallocates the data of the virtual area used by the application program P10 (2), which comprises a time limit, and, in addition, is a batch process type application.

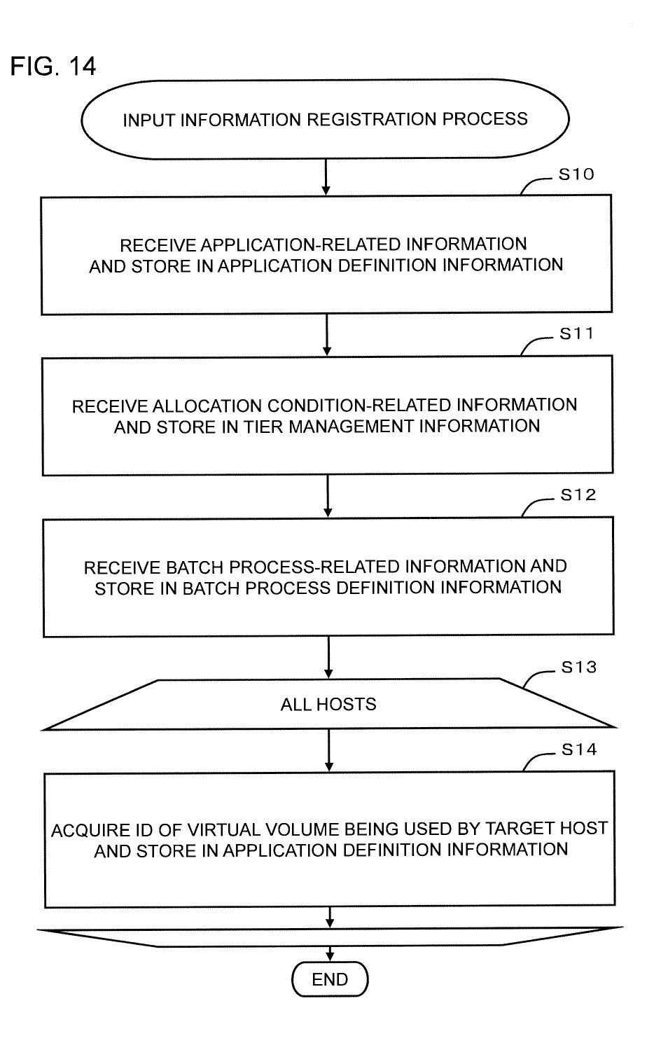

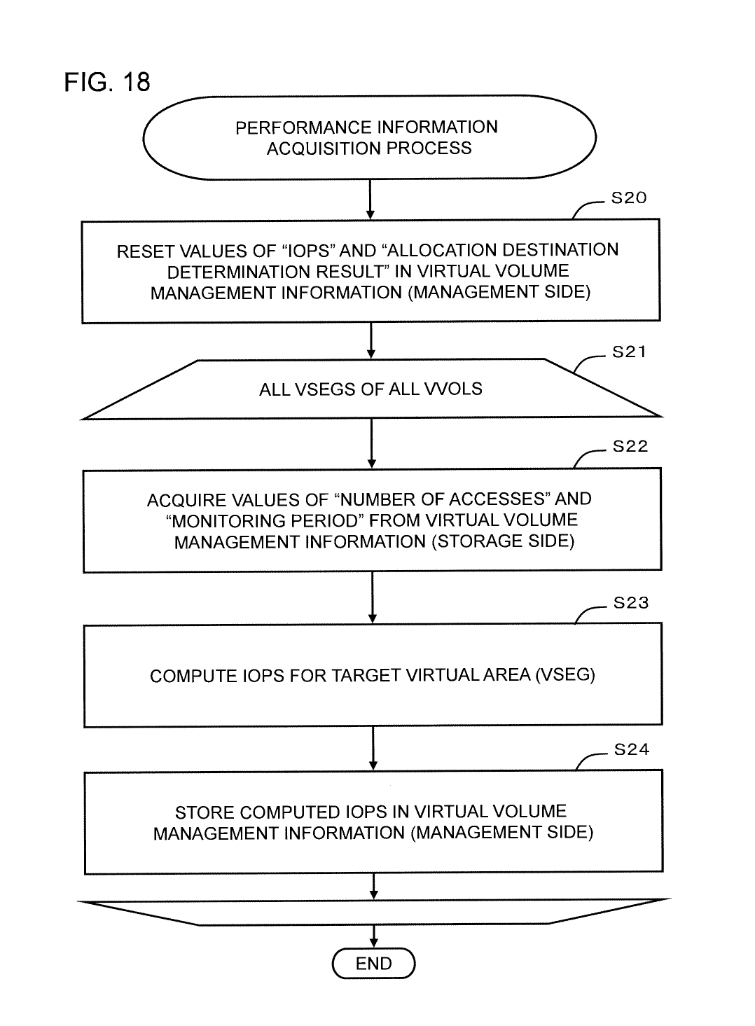

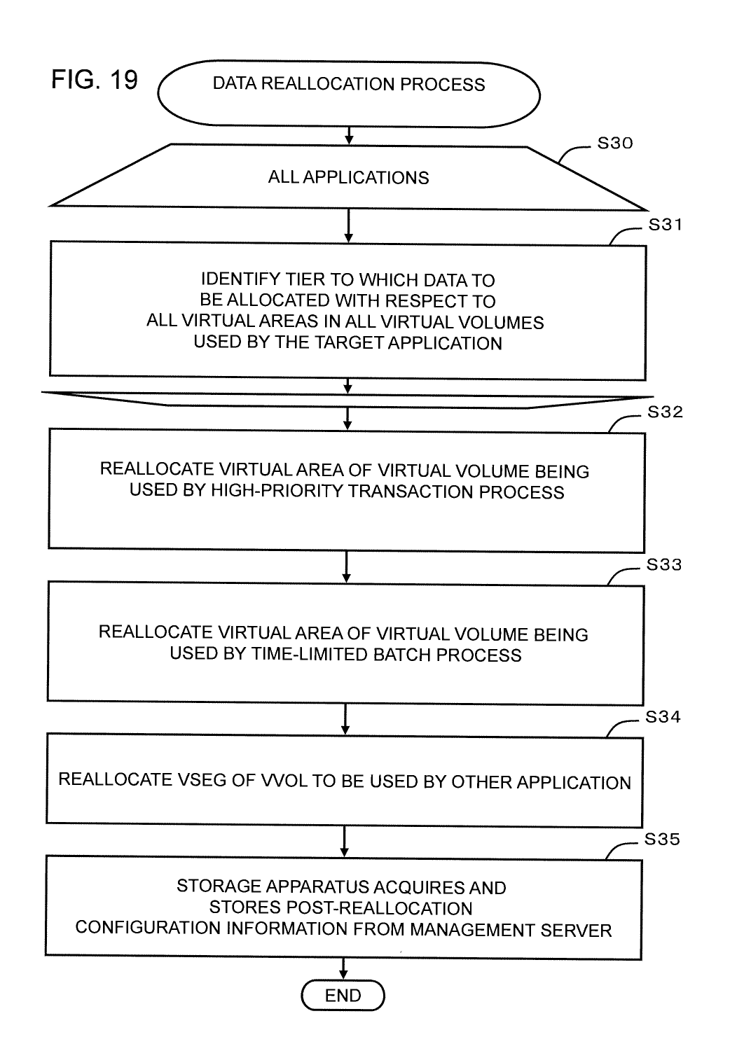

The input information registration processing program P300 will be explained in detail using FIG. 14. The performance information acquisition processing program P301 will be explained in detail using FIG. 18. The reallocation processing program P302 will be explained in detail using FIG. 19.

The RAID group management information T31, the actual area management information T32, and the virtual volume management information T33 of the management server 30 correspond respectively to the RAID group management information T20, the actual area management information T21, and the virtual volume management information T22 of the storage apparatus 20. However, the configurations of the respective management information T31, T32 and T33 in the management server 30 need not exactly match the configurations of the corresponding management information T20, T21 and T22.

The management server 30 acquires information from the management information T20, T21 and T22 of the storage apparatus 20, and stores this information in T31, T32 and T33 of the management server 30.

The auxiliary storage device 33 stores the application definition information T34 and the batch process definition information T35.

The application definition information T34 manages the priority of the application program P10 and attribute information such as the application type (a transaction process or a batch process).

The batch process definition information T35 manages the name of the application program that is carrying out a batch process, and the start-time and end-time of the batch process.

Furthermore, the configuration may also be such that the controller 26 of the storage apparatus 20 executes the respective processes carried out by the management server 30. That is, the configuration may be such that a computer system management function is provided inside the storage apparatus 20. Or, the configuration may be such that the management server 30 function is provided in any of the respective hosts 10.

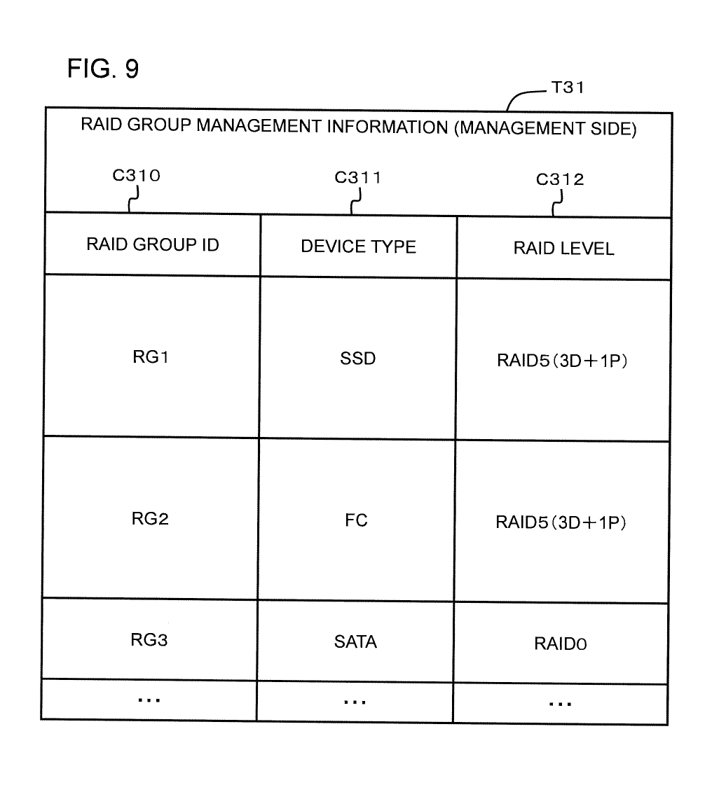

FIG. 9 shows an example of the configuration of the RAID group management information T31 of the management server 30. The RAID group management information T31 corresponds to the RAID group management information T20 of the storage apparatus 20, and is used for storing information that comprises the RAID group management information T20. However, the information of the RAID group management information T31 need not exactly match the information comprising the RAID group management information T20. A portion of the information comprising the RAID group management information T20 need not be stored in the RAID group management information T31.

For example, the RAID group management information T31 manages a RAID group ID C310 expressing the identifier of a RAID group 28, a device type C311 expressing the type of the storage device 27 comprising a RAID group 28, and a RAID level C312 denoting the RAID level and combination of a RAID group 28.

The actual area management information T32 of the management server 30 can be configured the same as the actual area management information T21 of the storage apparatus 20 shown in FIG. 6, and for this reason an explanation thereof will be omitted. Consequently, the actual area management information T32 may be explained below by referring to FIG. 6.

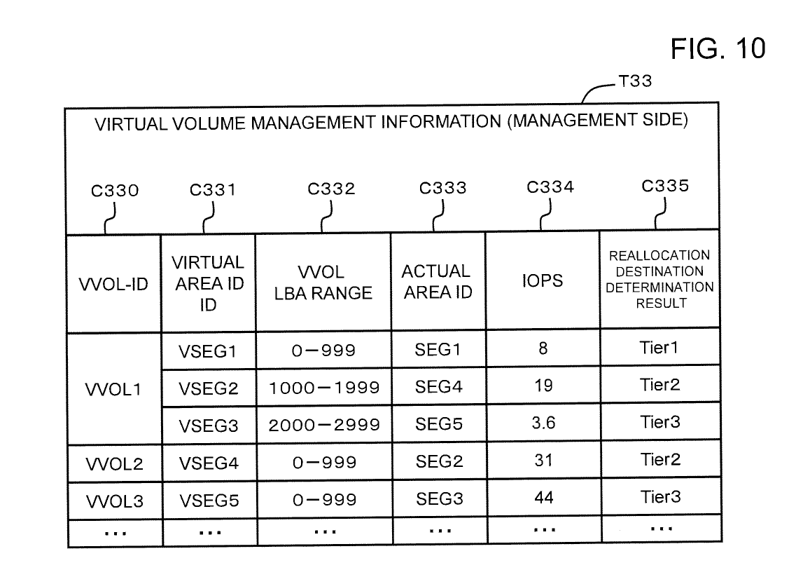

FIG. 10 is an example of the configuration of the virtual volume management information T33 of the management server 30. The virtual volume management information T33, for example, comprises a virtual volume ID C330, a virtual area ID C331, a virtual volume LBA range C332, an actual area ID C333, an IOPS C334, and a reallocation destination determination result C335.

Because the items C330, C331, C332, C333 and C335 correspond to items C220, C221, C222, C223 and C226 of the virtual volume management information T22 shown in FIG. 7, explanations thereof will be omitted.

In the virtual volume management information T33 of the management server 30, an item for the performance information monitoring period (C225 of FIG. 7) is not needed, and for this reason is not included.

In the virtual volume management information T22 of the storage apparatus 20, the number of times that accessing is carried out to a virtual area is recorded in the number of accesses C224. By contrast, in the virtual volume management information T33 of the management server 30, a value related to the number of accesses, which is used in the respective processes carried out by the management server 30, is recorded in the IOPS (average number of access) C334. For example, an average value of the number of accesses of the virtual area computer at the time of the previous processing (average value of the previous processing) is recorded in the TOPS C334.

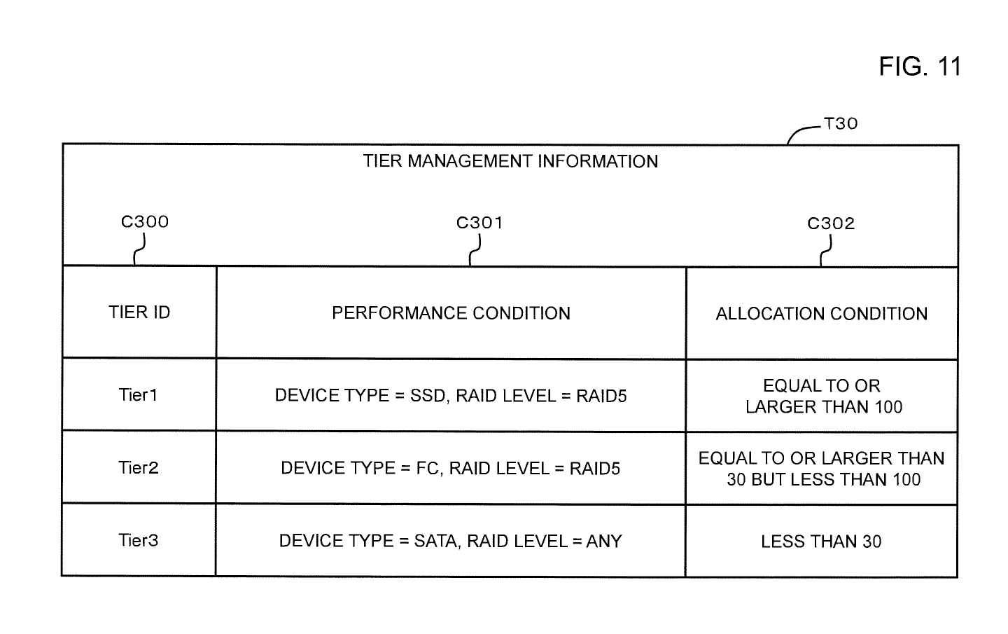

FIG. 11 shows an example of the configuration of the tier management information T30 of the management server 30. The tier management information T30 manages the performance of each tier 211, and a condition in a case where data is allocated to each tier 211. The tier management information T30 can be updated in accordance with a request from the user (system administrator).

The tier management information T30 comprises a tier ID C300, a performance condition C301, and a reallocation condition C302. An identifier of each tier 211 is configured in the tier ID C300. A value expressing a performance condition for each tier 211 is configured in the performance condition C301. A condition for allocating data to each tier is configured in the reallocation condition C302.

The performance condition C301, for example, can be defined as a combination of the type of the storage device 27 and the RAID level of the RAID group 28. In addition, the performance condition may also comprise another performance parameter, such as an access rate.

The reallocation condition is configured as a range of the number of accesses per unit of time with respect to data allocated to this tier. In the example shown in FIG. 11, data having an IOPS of equal to or greater than 100 can be allocated to the high-level tier 211A. Data with an IOPS of less than 100 cannot be stored in the actual area 212A in the high-level tier 211A. Data having an IOPS of equal to or greater than 30 but less than 100 (30≦IOPS<100) can be allocated to the medium-level tier 211B. Data with an IOPS of less than 30 and data with an IOSP of equal to or greater than 100 cannot be stored in the actual area 212B of the medium-level tier 211B. Data having an IOPS of less than 30 can be allocated to the low-level tier 211C. Data with an IOPS of equal to or more than 30 cannot be stored in the actual area 212C of the low-level tier 211C.

Furthermore, the value of the reallocation condition C302 may be a fixed value or a variable value. In another example, which will be explained further below, the value of the reallocation condition changes dynamically.

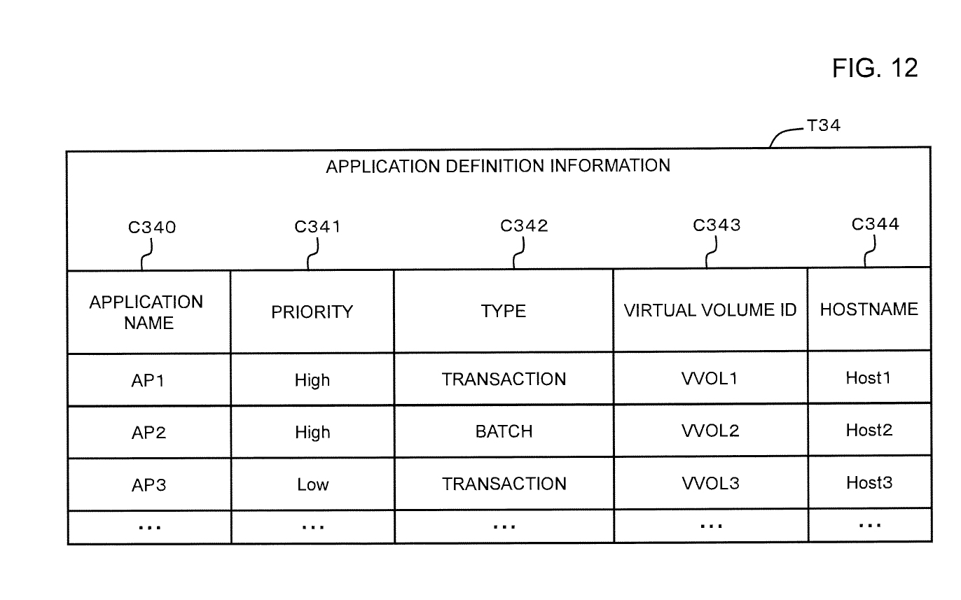

FIG. 12 is an example of the configuration of the application definition information T34. The application definition information T34 manages a prescribed attribute of the application program P10. The application definition information T34 manages an application name C340, a priority C341, a type C342, a virtual volume ID C343, and a hostname C344.

A character string for identifying an application program is configured in the application name C340. An application program priority is configured in the priority C341. Two priority values, i.e. “High” and “Low”, are provided. Three or more values may be provided instead. The priority, for example, is configured by the user based on the operating environment and/or the running environment of the application program. Instead of this, the configuration may be such that a setting criterion for automatically configuring the priority is prepared beforehand, and each application program priority is automatically configured in accordance with this setting criterion.

An application program type is configured in the type C342. Two application program types, i.e. “transaction process” and “batch process”, are provided.

The ID of the virtual volume that an application program is using is configured in the virtual volume ID C343. The configuration management program P30 queries the host configuration information acquisition processing program P11 to acquire the virtual volume ID. Identification information for identifying the host 10 that is running an application program is configured in the hostname C344.

The host configuration information T10 and the batch process definition information T35 will be explained by referring to FIG. 13. FIG. 13 (a) shows an example of the configuration of the batch process definition information T35. The batch process definition information T35, for example, correspondingly manages an application name C350 and a time window C351.

A name for identifying an application program P10, which is performing a batch process, is configured in the application name C350. A time range during which batch processing can be executed is configured in the time window C351. The time range, for example, is defined by a start-time (“From” in the drawing) to an end-time (“To” in the drawing). The time window is equivalent to the “time limit”. The batch process start-time denotes the earliest time at which the batch process can be executed. The batch process end-time denotes the batch process completion deadline.

FIG. 13 (b) shows an example of the configuration of the host configuration information T10. The host configuration information T10 stores the relation between a hostname C100 and the identifier C101 of virtual volume 220 that the host 10 is using.

The processing operation executed by the computer system will be explained by referring to FIGS. 14 through 23. FIG. 14 is a flowchart showing an information registration process for registering information inputted to the management server 30 in the management server 30.

The input information registration program P300 stores information that has been inputted by the user in the relevant item of the application definition information T34 (S10). The information inputted by the user may include the identifier of an application program P10 running on the host 10, a priority, a type, and the identifier of the host 10 that is running the application program P10. Furthermore, the configuration may be such that the input information registration program P330 automatically acquires either all or part of the information of these respective items from another computer program or the like. Furthermore, to expedite the explanations, the input information registration program P300 may be abbreviated as the registration program P300 hereinbelow.

The registration program P300, for example, receives a data allocation condition for each tier 211 as input information from the user, and stores these data allocation conditions in the item C302 corresponding to the tier management information T30 (S11).

The registration program P300 receives from among the respective application programs P10 a time-limited batch process application program P10, for example, as input information from the user, and stores this information in the batch process definition information T35 (S12). More specifically, the registration program P300 acquires from among the respective application programs registered in the application definition information T34 the identifier of an application program for which the type C342 is “batch process” and which comprises a time window-based time limit, and an execution start-time and an execution end-time for this application program, and stores this information in the item corresponding to the batch process definition information T35.

The registration program P300, for example, carries out the processing of S14 with respect to all the hosts that are running the application program P10 (S13). The processing-target host 10 will be called the target host hereinbelow.

The registration program P300 acquires the identifier of the virtual volume being used by the target host from the target host, and stores this information in the application definition information T34 (S14). Specifically, the registration program P300 queries the target host regarding the ID of the virtual volume that the target host is using, and acquires the host configuration information T10 from the target host. The registration program P300 stores the virtual volume identifier in the item corresponding to the application definition information T34 (the virtual volume ID C343 of the entry in which the hostname C344 is the same that of the target host) (S14).

The definition information related to the application registered in S10, the definition information with respect to the tier reallocation condition registered in S11, and the definition information related to the batch process execution condition (the time window) registered in S12 may be inputted manually by the user or may be provided in the management server 30 beforehand. In this example, a case in which the user manually inputs the respective definition information will be explained as an example.

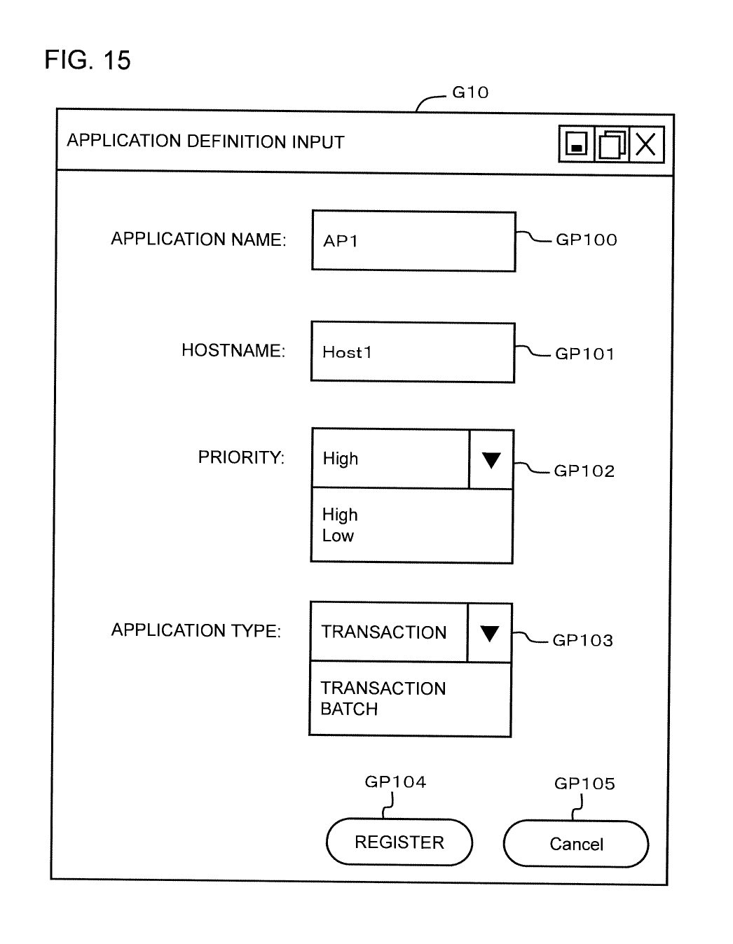

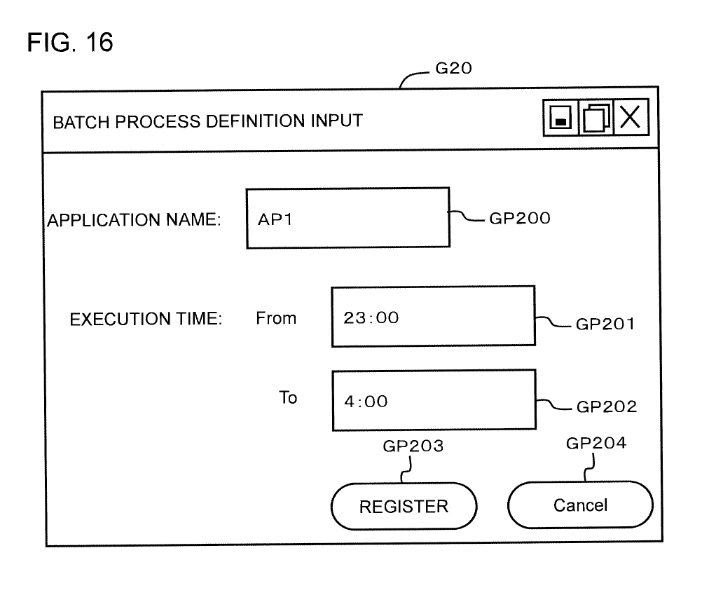

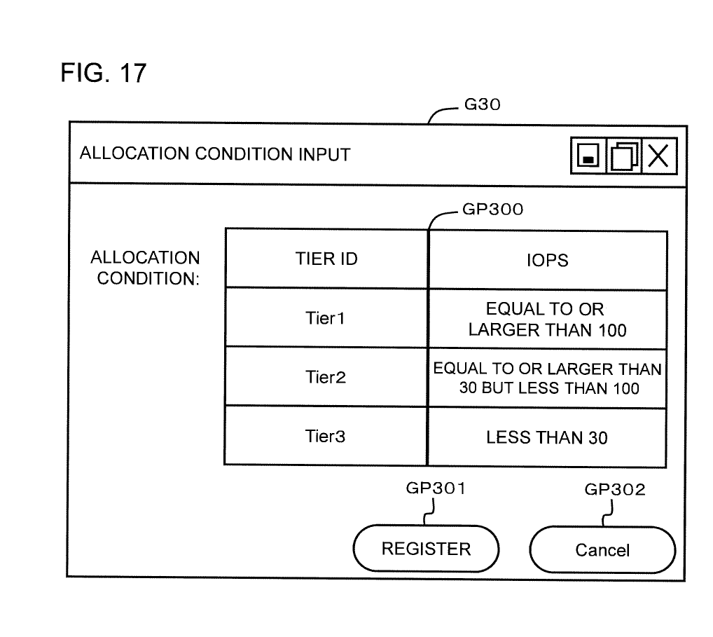

The configuration management program P30, in the above-mentioned input information registration process, displays an application definition information input screen G10 shown in FIG. 15, a batch process information input screen G20 shown in FIG. 16, and a tier allocation condition input screen G30 shown in FIG. 17 on the management terminal 40. These screens G10, G20 and G30 may be displayed as separate screens, or may be displayed collectively as a single screen.

Screen G10 shown in FIG. 15 is an example of a screen for registering application definition information in the management server 30. The screen G10, for example, comprises an application name input part GP100, a hostname input part GP101, a priority input part GP102, an application type input part GP103, a register button GP104, and a cancel button GP105.

The application name input part GP100 is an area for inputting the name of a management-target application program P10. The hostname input part GP101 is an area for inputting the name of the host 10 that will run the application program. The priority input part GP102 is an area for selecting a value that represents the priority of the application program. The application type input part GP103 is an area for selecting a value that represents the type of the application program.

For example, a text box for inputting either the application name or the hostname can be displayed in the application name input part GP100 and the hostname input part GP101. The user inputs either the application name or the hostname in this text box.

A pull-down menu for selecting one value from multiple options as the priority can be displayed in the priority input part GP102. For example, “High” and “Low” are the values that express the priority. The configuration may be such that the priority need not be limited to two values, but rather makes it possible to select a priority from among three or more values.

A pull-down menu for selecting one value from multiple options as the application program type can be displayed in the application type input part GP103. For example, “transaction” and “batch” are the values that express the application type.

The user presses the register button GP104 to register the content that has been inputted to the screen G10, and presses the cancel button GP105 to cancel the inputted content.

The screen G20 shown in FIG. 16 is an example of a screen for registering batch process definition information in the management server 30. The screen G20, for example, comprises an application name input part GP200, a start-time input part GP201, an end-time input part GP202, a register button GP203, and a cancel button GP204.

The application name input part GP200 is an area for inputting the name of the application program, which is a batch process. The user, for example, uses a text box or the like to input the name of the application program.

The start-time input part GP202 is an area for inputting the time at which the application program is scheduled to start. The end-time input part GP203 is an area for inputting the time at which the application program is scheduled to end. The period from the scheduled start-time to the scheduled end-time is equivalent to the time window.

The configuration may be such that a time is selected from among multiple times displayed in a pull-down menu, or such that a time is inputted to a text box or the like.

The user presses the register button GP203 when registering the content inputted to the screen G20. When cancelling the inputted content, the user presses the cancel button GP204.

The screen G30 shown in FIG. 17 is an example of a screen for registering a condition for allocating data to each tier 211 in the management server 30. The screen G30, for example, comprises an allocation condition input part GP300, a register button GP301, and a cancel button GP302.

The allocation condition input part GP300 is an area for inputting a condition for allocating data to each tier. The condition, for example, can be defined using a number of accesses (IOPS). In the example shown in the drawing, the conditions are configured such that data with an IOPS value that is equal to or larger than 100 (IOPS≧100) can be allocated to the high-level tier 211A, data with an IOPS value that is equal to or larger than 30 but less than 100 (30≦IOPS<100) can be allocated to the mid-level tier 211B, and data with an IOPS value that is less than 30 (IOPS<30) can be allocated to the low-level tier 211C. In other words, the condition for allocation to each tier is the number of times that each tier is allowed to be accessed.

The user presses the register button GP301 when registering the content that has been inputted to the screen G30. The user presses the cancel button GP302 when cancelling the inputted content.

The user uses the screen G10, the screen G20, and the screen G30 to input information, and when he presses the register button, the input information registration processing program P300 registers the inputted information in the respective corresponding definition information. The information that has been inputted to the screen G10 is registered in the application definition information T34 shown in FIG. 12. The information that has been inputted to the screen G20 is registered in the batch process definition information T35 shown in FIG. 13 (a). The information that has been inputted to the screen G30 is registered in the tier management information T30 shown in FIG. 11.

FIG. 18 is a flowchart showing a performance information acquisition process. This process is executed by the performance information acquisition processing program P301. In the explanation that follows, the performance information acquisition processing program P301 may be called the information acquisition program P301.

The information acquisition program P301 deletes all the data of the IOPS C334 and all the data of the reallocation destination determination result C335 in the virtual volume management information T33 that is stored in the management server 30 (S20).

The information acquisition program P301 executes the respective processing of S22, S23 and S24 with respect to all the virtual areas (VSEG) 221 of all the virtual volumes 220 (S21). Hereinafter, the processing-target virtual area 221 will be called the target virtual area.

The configuration management program P30 acquires a value of the number of accesses C224 and a value of the monitoring period C225, which correspond to the target virtual area, from the virtual volume management information T22 stored in the storage apparatus 20 (S22). For example, the configuration management program P30 sends a request to the storage apparatus 20 requesting number of accesses information corresponding to the target virtual area. This request comprises a virtual area ID (C221 of FIG. 7) for identifying the target virtual area 221.

The information acquisition program P301 computes the average value per unit of time (in units of IOPS) from the number of accesses and the monitoring period of the target virtual area (S23). The information acquisition program P301 registers the computed average value of the number of accesses in the relevant entry of the IOPS C334 of the virtual volume management information T33 of the management server side (S24).

FIG. 19 is a flowchart showing the processing for reallocating data. This processing is executed by the reallocation processing program P302. Hereinafter, the reallocation processing program P302 may be abbreviated as the reallocation program P302.

The reallocation program P302 carries out the processing of S31 with respect to all the application programs registered in the application definition information T34 (S30). Hereinafter, the processing-target application program will be called the target application program.

The reallocation program P302 determines the tier to which a virtual area is to be allocated with respect to all of the virtual areas in all of the virtual volumes used by the target application program P302, and registers this information in the virtual volume management information T33 (S31).

Specifically, the reallocation program P302 acquires the value of the IOPS (the average number of accesses) C334 that corresponds to the target virtual area, and acquires the ID of the tier corresponding to the allocation condition (allowable access range) that comprises this value from the tier management information T30.

The reallocation program P302 records the acquired tier ID (C300 of FIG. 11) in the reallocation destination determination result C335 of the virtual volume management information T33 as the tier in which the target virtual area data is to be allocated.

There may be cases in which the tier ID recorded in the reallocation destination determination result C335 of the virtual volume management information T33 matches the tier ID of the tier that comprises the actual area, which is currently being allocated to the target virtual area, and cases where this tier ID is different.

The reallocation program P302 executes reallocation processing with respect to each virtual area that is being used by a high-priority transaction process (S32). That is, the reallocation program P302 revises the tiers corresponding to these virtual areas with respect to all the virtual areas included in the virtual volume being used by the application program, which is a high priority, and, in addition, is of the application type “transaction process” (S32).

The reallocation program P302 executes the reallocation processing with respect to each virtual area being used by a time-limited batch process (S33). That is, the reallocation program P302 revises the tier corresponding to the virtual area with respect to all the virtual areas included in the virtual volume being used by the application program for which a time limit is configured, and, in addition, which is of the application type “batch process” (S33).

The reallocation program P302 executes the reallocation processing with respect to each virtual area being used by the other application program (S34). The other application program is the application program P10 (3), which is not equivalent to either the first application program P10 (1), which has a high priority, and, in addition, is a transaction process, or the second application program P10 (2), which is a time-limited batch process. For example, a transaction process that does not have a high priority or a batch process for which a time limit has not been configured is equivalent to the other application program.

The reallocation program P302 instructs the storage apparatus 20 to acquire the result that has been updated by S32, S33 and S34 from the virtual volume management information T33, and to update the contents of the virtual volume management information T22 of the storage apparatus side (S35).

The storage control program P20 of the storage apparatus 20, upon receiving the instruction from the reallocation program P302, acquires information from the virtual volume management information T33 of the management server side. The storage control program P20 updates the virtual volume management information T22 of the storage apparatus 20 side based on this acquired information.

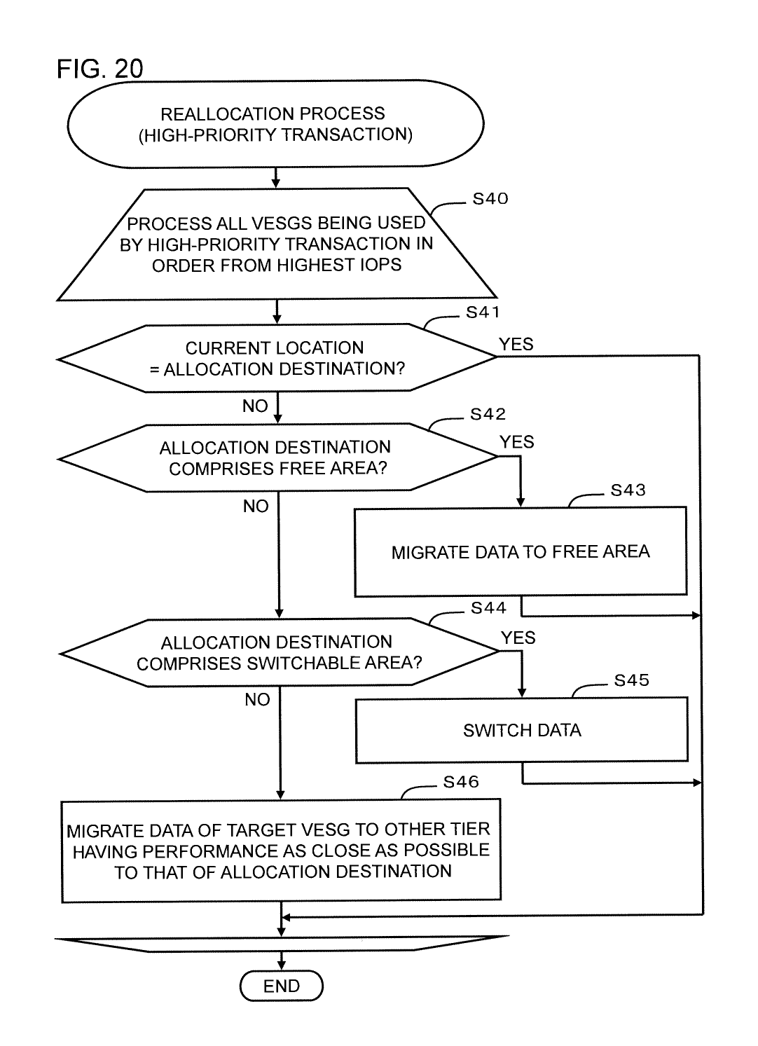

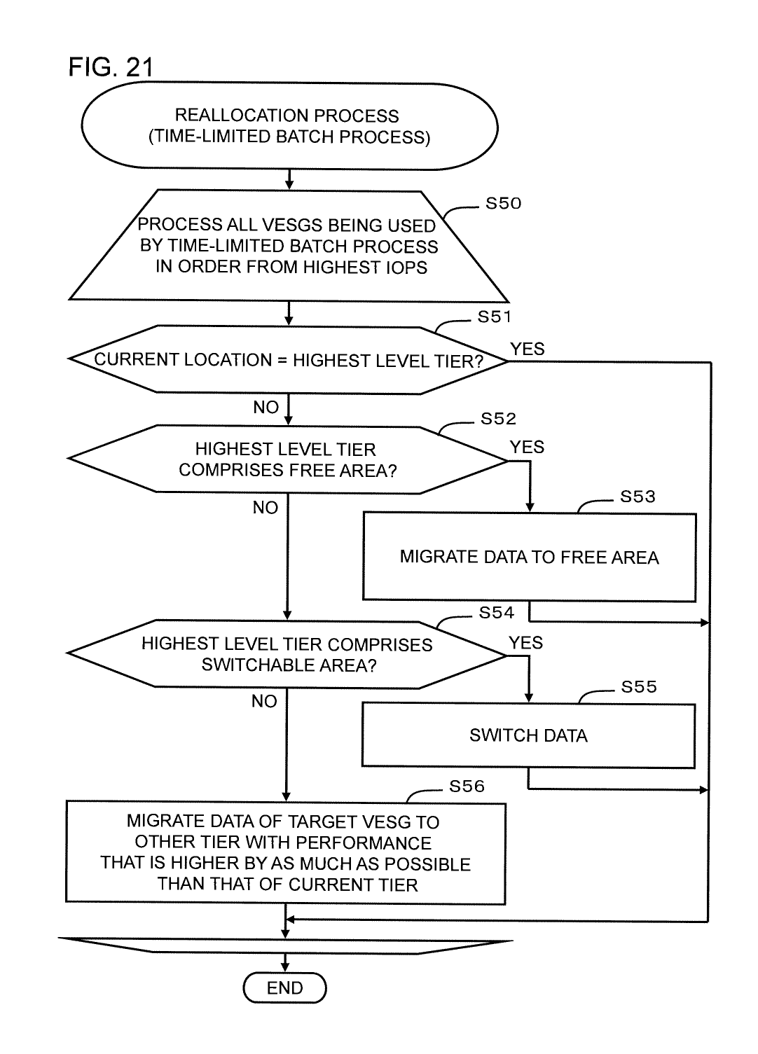

The processing details of S32 will be explained using FIG. 20. The processing details of S33 will be explained using FIG. 21. Since the processing details of S34 are substantially the same as the processing details of S32, an explanation of the processing of S34 will be omitted. The processing details of S34 can be understood by replacing “high-priority transaction process” in each step shown in FIG. 20 with “the other application program”.

FIG. 20 is a flowchart showing reallocation processing related to the high-priority transaction process. This processing is an example of S32 of FIG. 19.

The reallocation program P302 executes the processing of S41 through S46 with respect to all the virtual areas that belong to each virtual volume being used by the respective application programs, which are high-priority transaction processes (S40). The reallocation program P302 processes each virtual area in order from the virtual area with the highest IOPS.

The reallocation program P302 determines whether or not the ID of the tier corresponding to the actual area, which is currently allocated to the target virtual area, matches the value of the reallocation destination determination result (C335 of FIG. 10) corresponding to the target virtual area (S41). Hereinafter, the tier comprising the actual area currently allocated to the target virtual area may be called the allocation-source tier. The tier in which the reallocation destination determination result is registered may be called the reallocation-destination tier.

Specifically, the reallocation program P302 uses the actual area management information T32 to detect the ID of the actual area that is currently allocated to the target virtual area, and to identify the ID of the RAID group comprising this actual area ID. The reallocation program P302 uses the RAID group management information T31 to acquire the device type C311 and the RAID level C312 corresponding to the identified RAID group C310. The reallocation program P302 uses the tier management information T30 to identify the ID C300 of the tier comprising the performance condition C301 that matches the disk type and/or the RAID level. The reallocation program P302 determines whether or not the identified tier ID (the allocation-source tier ID) and the tier ID stored in the reallocation destination determination result C335 (the reallocation-destination tier ID) match (S41).

In a case where the ID of the allocation-source tier associated with the target virtual area and the ID of the reallocation-destination tier match (S41: YES), there is no need to migrate the data of the target virtual area. Consequently, the processing exits the loop.

In a case where the ID of the allocation-source tier associated with the target virtual area and the ID of the reallocation-destination tier do not match (S41: NO), the reallocation program P302 determines whether or not there is a free area inside the reallocation-destination tier (S42). A free area is an actual area that is not being allocated to a virtual volume from among the actual areas in the tier, and can also be called an unallocated area or an unused actual area.

In a case where there is a free area in the reallocation-destination tier (S42: YES), the processing proceeds to S43, which will be explained below. In a case where there is no free area in the reallocation-destination tier (S42: NO), the processing moves to S44.

Next, the processing details of S43 will be explained. The reallocation program P302 allocates an unused actual area inside the reallocation-destination tier to the target actual area in place of the currently allocated actual area (S43). The actual area, which belongs to the allocation-source tier, is the actual area of the data migration source. For the sake of convenience, this actual area may be called the migration-source actual area. The unused actual area belonging to the reallocation-destination tier is the actual area of the data migration destination. For convenience sake, this actual area may be called the migration-destination actual area.

Specifically, the reallocation program P302 uses the actual area management information T32 of the management server side to update the value of the allocation status corresponding to the ID of the migration-source actual area to “unallocated”, and, in addition, updates the value of the allocation status corresponding to the ID of the migration-destination actual area to “allocated”.

In this example, the actual area and the virtual area are managed so as to be the same size. Consequently, in this example, there is no need to take into account whether or not the size of the migration-source actual area matches the size of the migration-destination actual area at data migration time.

The reallocation program P302 updates the value of the actual area ID C333 corresponding to the target virtual area of the virtual volume management information T33 to the ID of the migration-destination actual area.

The reallocation program P302 instructs the storage apparatus 20 to migrate data from the migration-source actual area to the migration-destination actual area.

The storage control program P20 of the storage apparatus 20, upon receiving the instruction from the reallocation program P302, migrates the data from the migration-source actual area to the migration-destination actual area.

Furthermore, the performance of another virtual volume may be affected when S43 is executed. For example, all of the unallocated actual areas in the high-level tier may be used up as a result of reallocation processing being carried out for a certain virtual volume. In accordance with this, it becomes impossible to allocate an unallocated actual area inside the high-level tier to a virtual area in the other virtual volume.

Consequently, in a case where there is a virtual area to which it has been determined that an actual area inside the high-level tier should be allocated, as in the processing of S45, which will be explained hereinbelow, either the data is switched with that of another virtual area to which an actual area inside the high-level tier is allocated, or an actual area of another lower performance tier (for example, the mid-level tier) is allocated. For this reason, performance is likely to be affected.

To deal with a situation like this, for example, instead of allocating a new actual area to the virtual area of the target virtual volume, an actual area, which is already being used by another virtual area inside the target virtual volume, may be substituted. That is, a high-level tier actual area allocated to a certain virtual area of the target virtual volume may be allocated to another virtual area of the target virtual volume. Simply stated, an allocated high-level actual area in the target virtual volume is circulated within the target virtual volume.

The reallocation program P302 determines whether or not to use an unallocated actual area in the reallocation process, for example, in accordance with the number and/or percentage of unallocated actual areas inside each tier.

Specifically, even when an unallocated actual area exists inside the reallocation-destination tier in the processing of S42, the reallocation program P302 migrates data in the processing of S44 in a case where the number of these unallocated actual areas is less than 10 percent of all the actual areas in the reallocation destination tier.

The processing details of S44 will be explained. The reallocation program P302 determines whether or not there exists inside the reallocation-destination tier an actual area which is able to switch data with the actual area that is allocated to the target virtual area (S44). For convenience sake, this may be expressed as whether or not a switchable virtual area exists in the reallocation-destination tier.

Specifically, the reallocation program P302 refers to the actual area management information T32 and the virtual volume management information T33 and determines whether or not there exists a reallocation destination determination result corresponding to a virtual area, to which an actual area from among the allocated actual areas in the reallocation-destination tier is allocated, matches the allocation-source tier. For example, in a case where data is to be migrated from a mid-level tier to a high-level tier, a determination is made as to whether or not there is a virtual area for which a migration to the mid-level tier is scheduled among the virtual areas corresponding to the allocated actual areas of the high-level tier.

In a case where a switchable actual area exists (S44: YES), the processing proceeds to S45. In a case where a switchable actual area does not exist (S44: NO), the processing moves to S46.

The details of S45 will be explained. The reallocation program P302 switches the allocation status with respect to the virtual area of the actual area allocated to the target virtual area (hereinafter, the switch-source actual area) with the allocated actual area of the reallocation-destination tier (hereinafter, the switch-destination actual area) (S45).

Specifically, the reallocation program P302 stores the ID of the switch-destination actual area in the entry in which the ID of the switch-source actual area is stored in the actual area ID C333 of the virtual volume management information T33. In addition, the reallocation program P302 stores the ID of the switch-source actual area in the entry in which the ID of the switch-destination actual area is stored in the actual area ID C333 of the virtual volume management information T33.

The reallocation program P302 instructs the storage apparatus 20 to switch the data between the switch-source actual area and the switch-destination actual area. The storage control program P20 of the storage apparatus 20, upon receiving the instruction from the reallocation program P302, switches the data between the specified actual areas.

For example, the storage control program P20 can switch the data by carrying out the processing described below. Furthermore, an unallocated actual area of the storage apparatus 20 may be used as a cache memory area instead of the cache memory area of the below-described processing.

Step 1: The storage control program P20 copies the data inside the switch-source actual area to the cache memory area.
Step 2: The storage control program P20 copies the data inside the switch-destination actual area to the cache memory area.
Step 3: The storage control program P20 writes the data of the switch-source actual area from the cache memory area to the switch-destination actual area.
Step 4: The storage control program P20 writes the data of the switch-destination actual area from the cache memory area to the switch-source actual area.

In a case where the reallocation-destination tier does not comprise a switchable actual area (S44: NO), the reallocation program P302 migrates the data in the actual area allocated to the target virtual area to an unallocated actual area inside another tier having performance that is as close as possible to that of the reallocation-destination tier (S46). In addition, the reallocation program P302 upgrades the virtual volume management information T33 and the actual area management information T32 and ends the processing. In a case where there is an unprocessed virtual area, the processing returns to S41.

FIG. 21 is a flowchart showing reallocation processing related to a time-limited batch process. This processing is an example of S33 of FIG. 19. The explanation will focus on the differences with FIG. 20.

The reallocation program P302 carries out the processing of S51 through S56 with respect to all the virtual areas belonging to all the virtual volumes to be used by the respective application programs registered in the batch process definition information T35 (S50). The reallocation program P302 processes the respective virtual areas in order from that having the highest average number of accesses (IOPS) C334 value.

The reallocation program P302 determines whether or not the ID of the tier corresponding to the actual area currently allocated to the target virtual area matches the ID of the highest level tier 211A of the respective tiers 211A, 211B and 211C (S51). The ID of the highest level tier 211A can be acquired from the tier management information T30. In this example, the high-level tier 211A is equivalent to the highest level tier.

In a case where the ID of the allocation-source tier, which is associated with the target virtual area, is the ID of the highest level tier (S51: YES), there is no need to migrate the data of the target virtual area. Consequently, the processing ends.

Alternatively, in a case where the ID of the allocation-source tier of the target virtual area is not the ID of the highest level tier (S51: NO), the reallocation program P302 determines whether or not there is a free area in the highest level tier (S52).

In a case where there is a free area in the highest level tier (S52: YES), the processing moves to S53, which will be explained hereinbelow. Alternatively, in a case where there is no free area in the highest level tier (S52: NO), the processing moves to S54, which will be explained further below.

S53 will be explained. The reallocation program P302 allocates an unused actual area in the highest level tier in place of the actual area currently allocated to the target virtual area (S53). An actual area belonging to the allocation-source tier is the data migration-source actual area. For the sake of convenience, this actual area may be called the migration-source actual area. An unused actual area belonging to the highest level tier is the data migration-destination actual area. For convenience sake, this may be called the migration-destination actual area.

Specifically, the reallocation program P302 uses the actual area management information T32 of the management side to update the value of the allocation status corresponding to the ID of the migration-source actual area to “unallocated”, and, in addition, updates the value of the allocation status corresponding to the ID of the migration-destination actual area to “allocated”.

The reallocation program P302 updates the value of the actual area ID C333 corresponding to the target virtual area in the virtual volume management information T33 to the ID of the migration-destination actual area.

The reallocation program P302 instructs the storage apparatus 20 to migrate data from the migration-source actual area to the migration-destination actual area. The storage control program P20 of the storage apparatus 20, upon receiving the instruction from the reallocation program P302, migrates the data from the migration-source actual area to the migration-destination actual area.

S54 will be explained. The reallocation program P302 determines whether or not an actual area, which is capable of switching data with the actual area allocated to the target virtual area, exists inside the highest level tier (S54).

Specifically, the reallocation program P302 refers to the actual area management information T32 and the virtual volume management information T33 and determines whether or not there exists a reallocation destination determination result corresponding to a virtual area, to which an actual area from among the allocated actual areas in the highest level tier is allocated, matches the allocation-source tier.

In a case where a switchable actual area exists (S54: YES), the processing proceeds to S55. In a case where a switchable actual area does not exist (S54: NO), the processing moves to S56.

The details of S55 will be explained. The reallocation program P302 switches the allocation status of the virtual area between the actual area allocated to the target virtual area (hereinafter, the switch-source actual area) and the allocated actual area of the highest level tier (hereinafter, the switch-destination actual area) (S55).

The reallocation program P302 instructs the storage apparatus 20 to switch the data between the switch-source actual area and the switch-destination actual area. The storage control program P20, upon receiving the instruction from the reallocation program P302, switches the data between the specified actual areas.

In a case where the highest level tier does not comprise a switchable actual area (S54: NO), the reallocation program P302 migrates the data of the target virtual area to a tier with higher performance than the current tier (the allocation-source tier) (S56). The reallocation program P302 updates the virtual volume management information T33 and the actual area management information T32 and ends the processing. In a case where there is an unprocessed virtual area, the processing returns to S51.

In S56, the reallocation program P302, in a case where either an unallocated actual area exists inside a higher level tier than the allocation-source tier or there is a switchable actual area, migrates the data in the actual area allocated to the target virtual area to either the unallocated actual area or the switchable actual area. Examples of the data migration method and the switching method have been explained in detail using FIG. 20, and as such explanations thereof using FIG. 21 will be omitted.

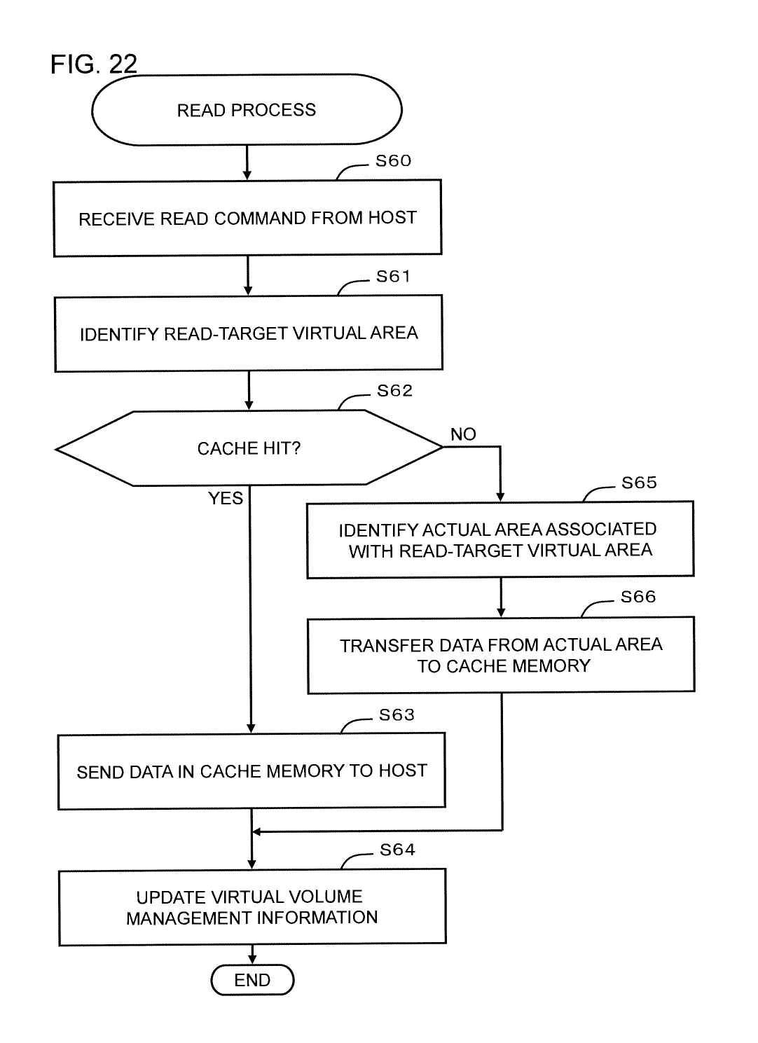

FIG. 22 is a flowchart showing a read process. This processing is executed by the storage control program P20 of the storage apparatus 20.

The storage control program P20 receives a read request (a read command) from the host 10 (S60). The storage control program P20 identifies a virtual area, which is the data read target (hereinafter, the read-target virtual area) based on access destination information of the read request (S61).

The storage control program P20 determines whether or not the read-target data exists in the cache memory (S62).

In a case where the read-target data is in the cache memory (S62: YES), the storage control program P20 sends the read-target data in the cache memory to the host 10 (S63).

In a case where the read-target data is not in the cache memory (S62: NO), the storage control program P20 identifies the actual area allocated to the read-target virtual area identified in S61 (hereinafter, the read-target actual area) based on the virtual volume management information T22 (S65).

The storage control program P20 reads the data from the read-target actual area, and writes this data to the cache memory (S66). In addition, the storage control program P20 sends the data that was written to the cache memory to the host 10 (S63).

Lastly, the storage control program P20 updates the value of the number of accesses C224 corresponding to the read-target virtual area in the virtual volume management information T22 (S67).

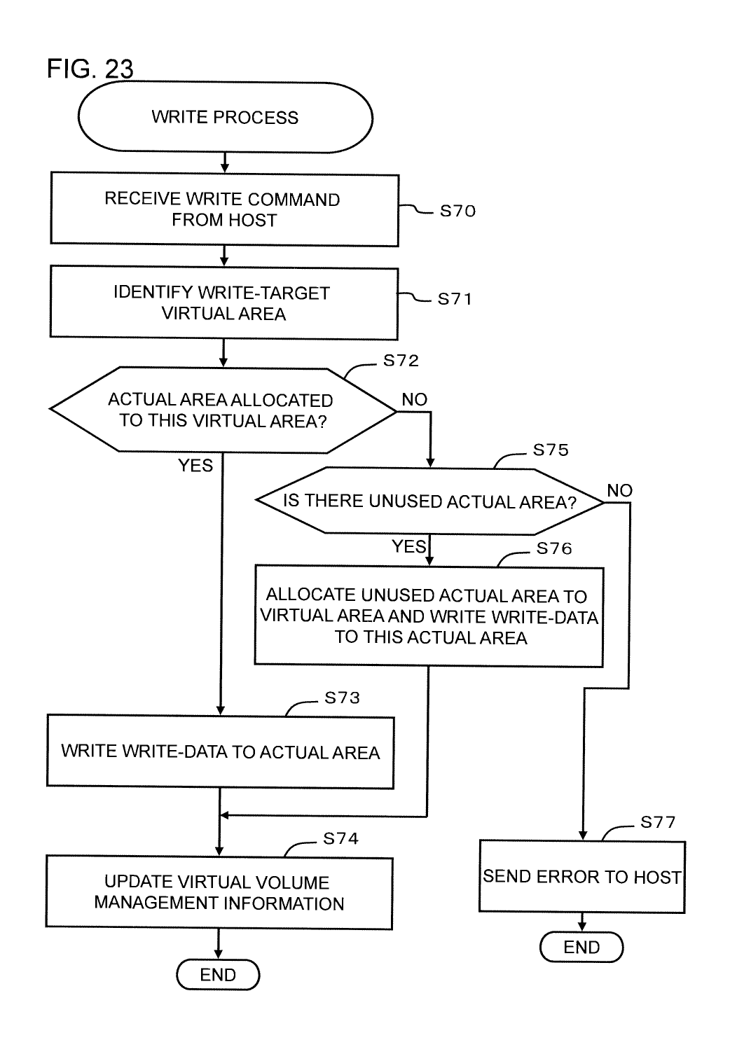

FIG. 23 is a flowchart showing a write process. This processing is executed by the storage control program P20.

The storage control program P20, upon receiving a write request from the host 10 (S70), identifies based on access destination information of the write requests the virtual area, which is to be the destination of the data write (the write-target virtual area) (S71).

The storage control program P20 determines whether or not an actual area has been allocated to the write-target virtual area (S72). Specifically, the storage control program P20 determines whether or not the write-target virtual area is registered in the virtual volume management information T22.

In a case where an actual area is allocated to the write-target virtual area (S72: YES), the storage control program P20 writes the write-target data to the actual area allocated to the write-target virtual area (S73).

In a case where an actual area has not been allocated to the write-target virtual area (S72: NO), the storage control program P20 determines whether or not an unallocated actual area capable of being allocated to the write-target virtual area exists (S75). Specifically, the storage control program P20 determines whether or not there is an actual area for which the allocation status C213 of the actual area management information T21 is configured as “unallocated”.

In a case where an unallocated actual area exists with respect to the write-target virtual area (S75: YES), the storage control program P20 allocates the unallocated actual area to the write-target virtual area and writes the write-target data to this actual area (S76).

In a case where an unallocated actual area does not exist for the write-target virtual area (S75: NO), the storage control program P20 sends an error message to the host 10 (S77).

Lastly, the storage control program P20 upgrades the value of the number of accesses C224 corresponding to the write-target virtual area in the virtual volume management information T22 (S74).

This example, which is configured in this manner, revises the allocation of an actual area to a virtual area related to a high-priority transaction process, and subsequently revises the allocation of an actual area to a virtual area related to a time-limited batch process.

Consequently, in this example, in a case where a high-priority transaction process and a time-limited batch process use a pool 210 comprising multiple tiers 211 with different performance, both the performance condition of the high-priority transaction process and the time limit configured with respect to the batch process can be satisfied.

In this example, since storage areas of the respective tiers, which feature different performance, are allocated to a virtual area inside a virtual volume in actual area units of a prescribed size, the storage area of each tier can be used efficiently, making it possible to lower storage apparatus 20 costs.

### Example 2

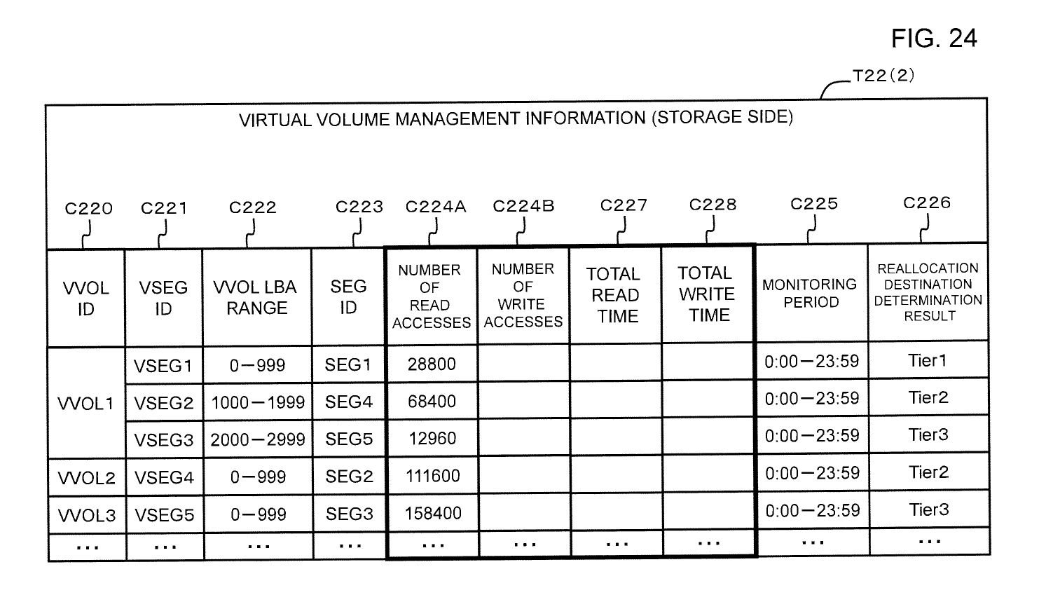

A second example will be explained by referring to FIGS. 24 through 32. Each of the examples that follow, to include this example, is equivalent to a variation of the first example. Consequently, the explanations will focus on the differences with the first example.

In the second example, an estimate of the time required to complete batch processing is made, and in a case where it has been determined that this batch processing will not be completed within the limited time period (time limit), a notification is sent to the user.

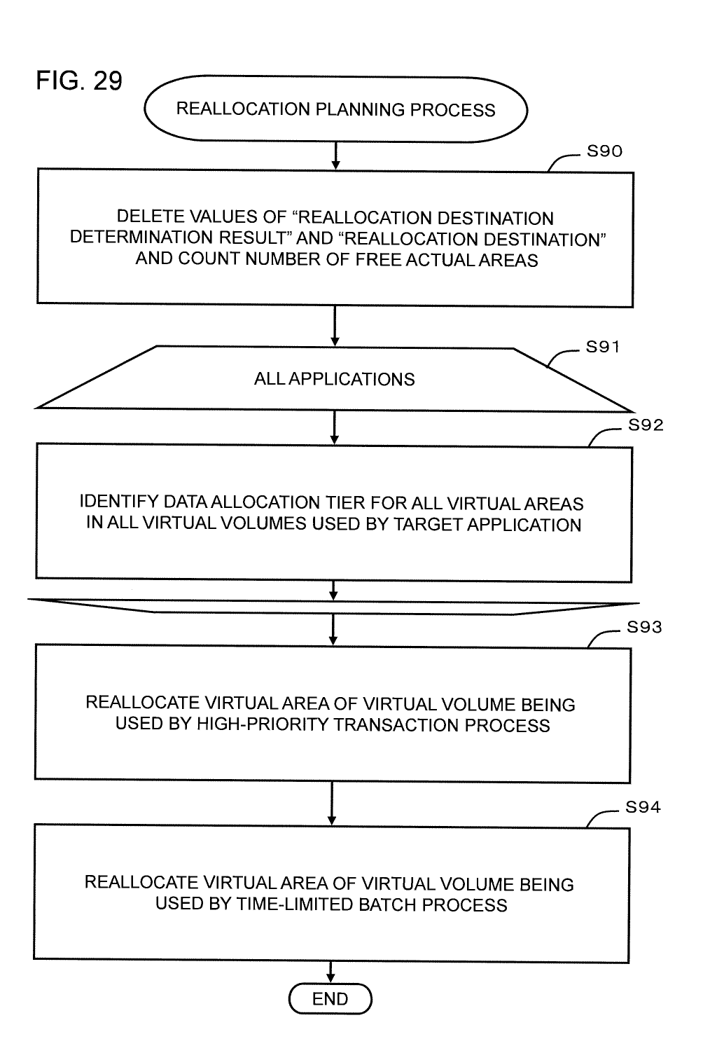

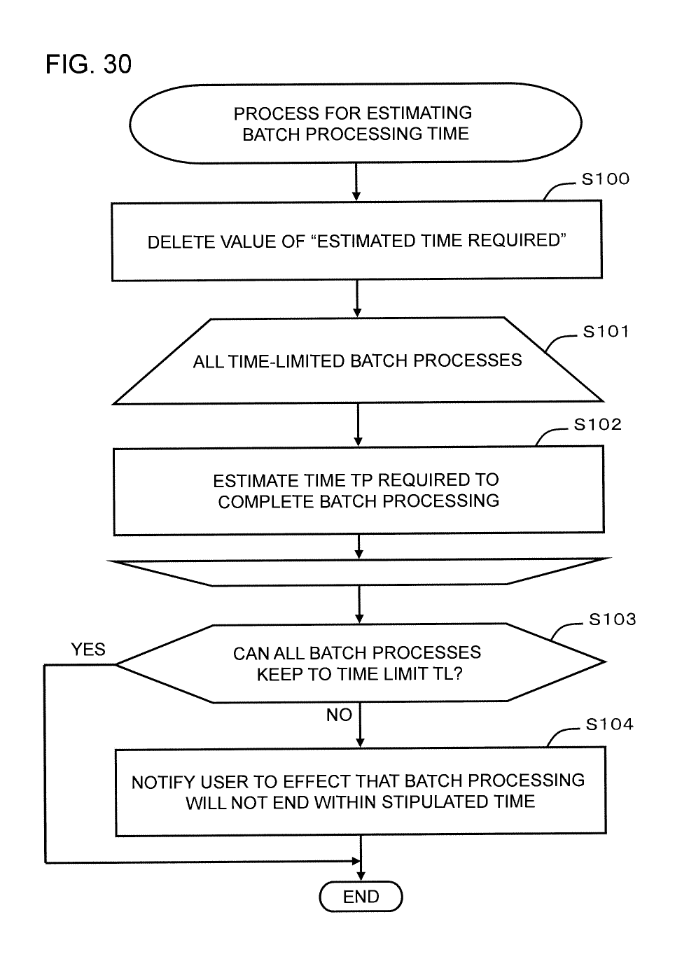

A configuration management program P30 according to the second example also executes a process for creating a reallocation plan (FIG. 29) and a process for estimating a batch process time (FIG. 30) in addition to the respective processes (the input information registration process, the performance information acquisition process, and the reallocation process) described in the first example. Although not shown in the drawings, in the configuration management program P30 according to the second example, a processing program for creating a reallocation plan (reference sign would be P303) and a processing program for estimating a batch process time (reference sign would be P304) can be provided.

Details will be explained further below, but in the reallocation planning process, first of all, the reallocation destination of a virtual area to be used by an application program, which is high priority and, in addition, is a transaction process type application, is determined, and next, the reallocation destination of a virtual area to be used by an application program, which has a time limit and, in addition, is a batch process type application, is determined, and the determined reallocation destinations are recorded in the management server-side virtual volume management information T33.

In the reallocation process of this example, the data of each virtual area is reallocated in accordance with the reallocation destination determination result recorded in the virtual volume management information T33.

The batch process time estimation process of this example estimates the time required to execute a batch process in a case where the virtual area used by the application program, which carries out the batch processing, has been moved to the reallocation destination determined by the reallocation planning process. In addition, in a case where the estimated time does not meet the time limit configured with respect to the batch process, the batch process time estimation process notifies the user.

FIG. 24 shows virtual volume management information T22 (2) according to this example. The virtual volume management information T22 (2) shown in FIG. 24 comprises items C220 through C223, C225 and C226 that are shared in common with the virtual volume management information T22 shown in FIG. 7. The virtual volume management information T22 (2) comprises items C224A and C224B in place of item C224 shown in FIG. 7, and, in addition, comprises new items C227 and C228.

The points of difference will be explained. A number of read accesses C224A records the number of read accesses with respect to a virtual area. The number of read accesses is the number of times a read request has been received. A number of write accesses C224B records the number of write accesses with respect to a virtual area. The number of write accesses is the number of times that a write request has been received.

A total read time C227 records a value for the total read time with respect to a virtual area. The total read time is a value representing the total time required by the storage apparatus 20 for read processing. The time required for read processing is the read request response time. The read request response time is the time required from receipt of a read request from the host until the read-target data has been sent to the host.

A total write time C228 records a value representing the total write time with respect to a virtual area. The total write processing time is a value representing the total time required by the storage apparatus 20 for write processing. The time required for write processing is the write request response time. The write request response time is the time required from receipt of a write request from the host until the write-target data is written to the actual area allocated to the write-target virtual area.

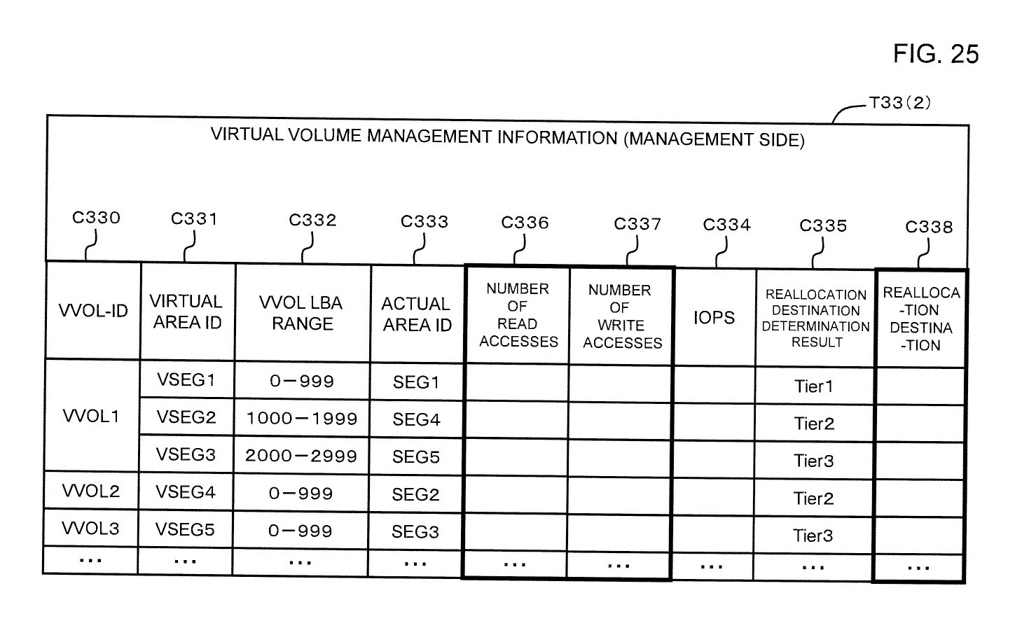

FIG. 25 shows management-side virtual volume management information T33 (2). The virtual volume management information T33 (2) shown in FIG. 25 shares items C330 through C335 in common with the virtual volume management information T33 shown in FIG. 10. In addition, the virtual volume management information T33 (2) comprises the new items C336, C337 and C338.

A number of read accesses C336 is the same as the number of read accesses C224A of FIG. 24. A number of write accesses C337 is the same as the number of write accesses C224B of FIG. 24. A reallocation destination C338 records the tier, which is the actual destination for data being reallocated, based on the value of the reallocation destination determination result C335.

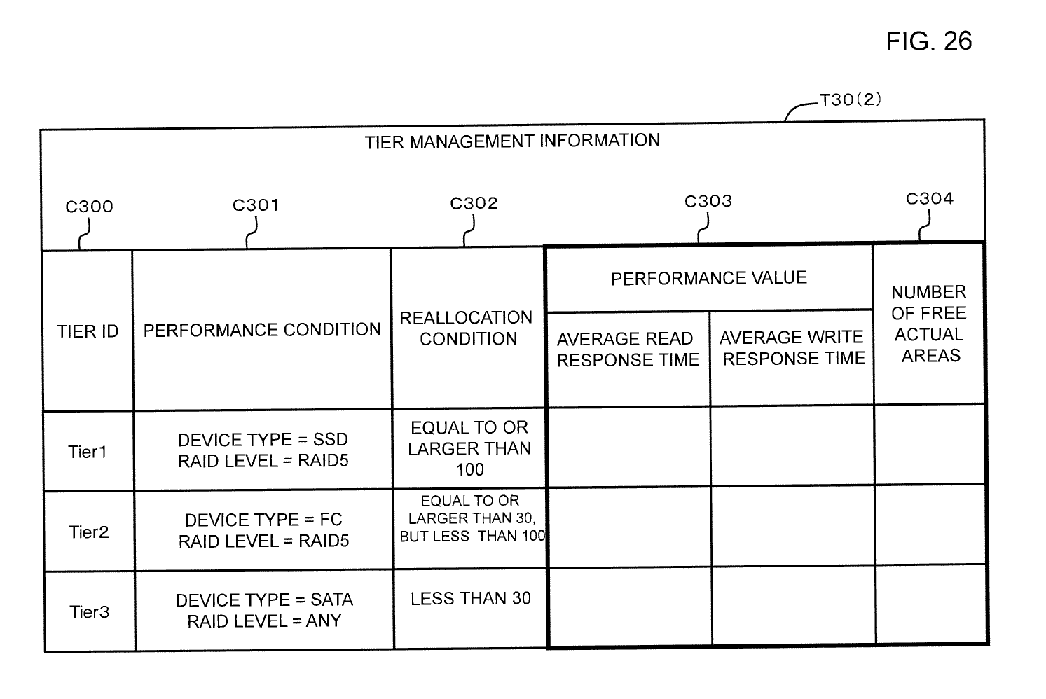

FIG. 26 shows tier management information T30 (2) according to this example. The tier management information T30 (2) shown in FIG. 26 comprises items C300, C301 and C302 that are shared in common with the tier management information T30 shown in FIG. 11, and, in addition, comprises the new items C303 and C304.

A performance value C303 stores a performance value related to the actual areas belonging to the respective tiers. The performance value, for example, comprises an average read response time and an average write response time. The average read response time is an average value of the response times of read requests with respect to an actual area belonging to a tier. The average write response time is an average value of the response times of write request with respect to an actual area belonging to a tier.

A number of free areas C304 stores the number of unallocated actual areas among the respective actual areas belonging to the tier.

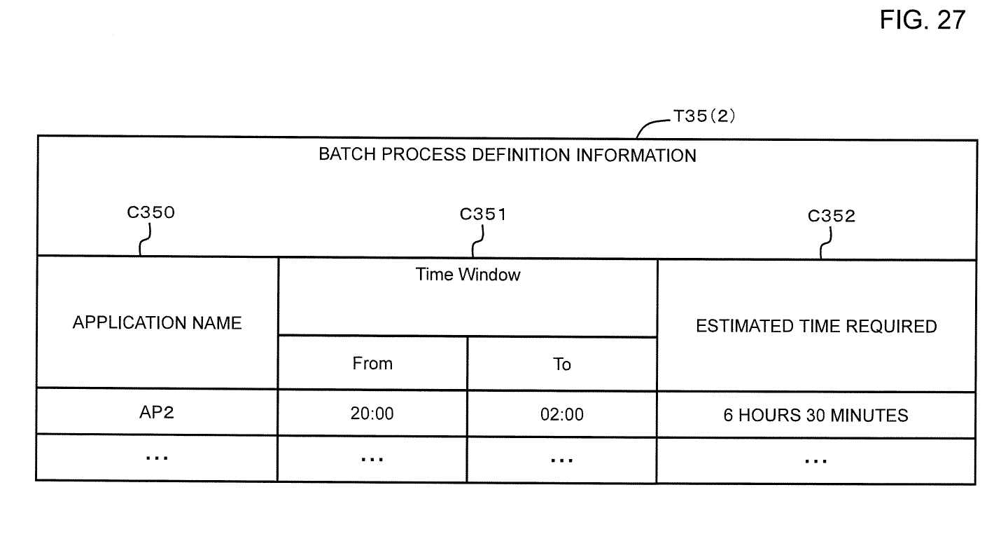

FIG. 27 shows batch process definition information T35 (2). The batch process definition information T35 (2) according to this example comprises items C350 and C351 that are shared in common with the batch process definition information T35 shown in FIG. 13 (a), and, in addition, comprises the new item C352.

An estimated time required C352 records a time estimated to be required to complete a batch process. That is, the estimated time required C352 is an estimated value of the time it will take from the start of the next batch process until the end.

The processing details of this example will be explained. This example measures the response times in the read processing (FIG. 22) and the write processing (FIG. 23) described in the first example. Although not shown in the drawing, a first timer is started when a read request has been received from the host 10, and the first timer is stopped when the read-target data is sent to the host 10. The value measured in accordance with the first timer is the read request response time. Similarly, a second timer is started when a write request has been received from the host 10, and the second timer is stopped when the write request processing has been completed. The value measured in accordance with the second timer is the write request response time. Furthermore, the write request processing is complete at the point in time when the write-target data has been written to the actual area corresponding to the write-target virtual area.

This example measures the number of read accesses and computes the total read time. Similarly, this example measures the number of write accesses and computes the total write time. The process for computing the total read time may be executed during read processing, or may be executed separately from the read process. Similarly, the process for computing the total write time may be executed during write processing, or may be executed separately from the write process.

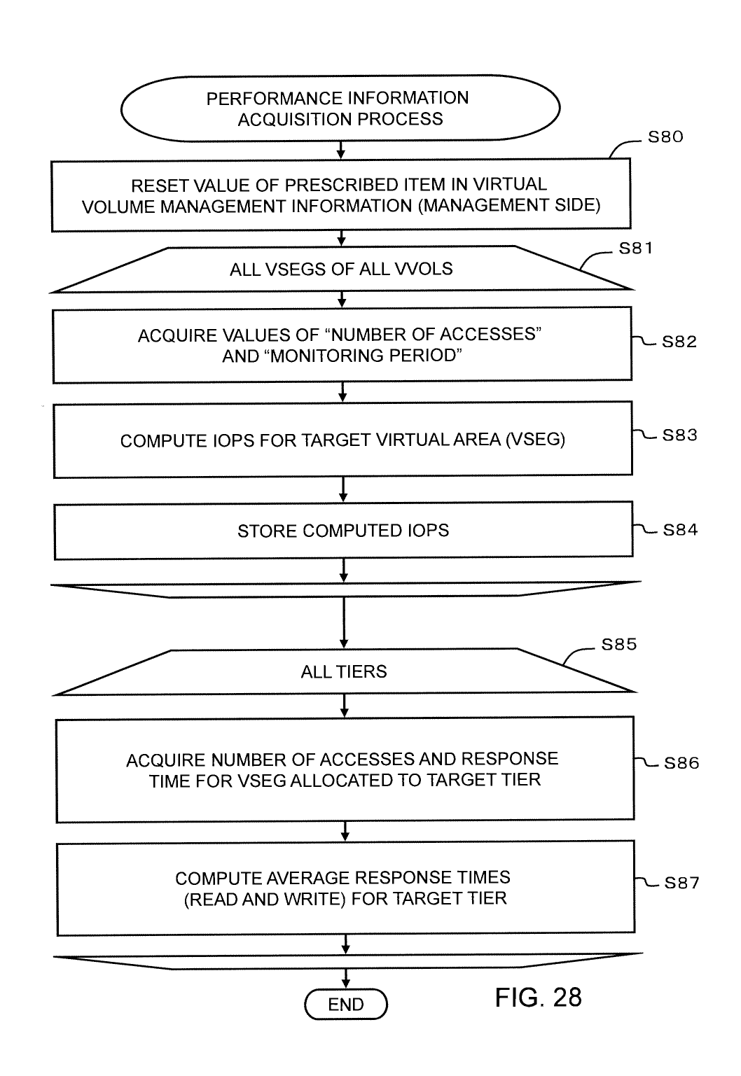

FIG. 28 is a flowchart of a performance information acquisition process according to this example. This processing is executed by the performance information acquisition processing program P301 of the management server 30. The performance information acquisition processing program P301 will be called the information acquisition processing program P301 here.

The information acquisition program P301 deletes all the values of prescribed items in the virtual volume management information T33 (2) stored in the management server 30 (S80). The prescribed items are the number of read accesses C336, the number of write accesses C337, the average number of accesses (IOPS) C334, the reallocation destination determination result C335, and the reallocation destination C338.

The information acquisition program P301 executes the respective processing of S82, S83 and S84 with respect to all of the virtual areas (VSEGs) 221 of all of the virtual volumes 220 (S81).

The configuration management program P30 acquires each of the value of the number of read accesses C224A, the value of the number of write accesses C224B, and the value of the monitoring period C225 corresponding to the target virtual area from the virtual volume management information T22 (2) stored in the storage apparatus 20 (S82).

The information acquisition program P301 computes the average value per unit of time (in TOPS units) from the number of read accesses, the number of write accesses and the monitoring period of the target virtual area (S83). The information acquisition program P301 registers the computed average number of accesses value in the relevant entry of the IOPS C334 of the management server virtual volume management information T33 (2) (S84).

In addition, the information acquisition program P301 executes the processing of S86 and S87 with respect to all of the tiers 211 (S85).

The information acquisition program P301 acquires from the virtual volume management information T22 (2) of the storage apparatus 20 the number of read accesses C224A and the number of write accesses C224B to the virtual area associated with an actual area inside the target tier, and the total read time C227 and the total write time C228 (S86).

The information acquisition program P301 computes the read request average response time and the write request average response time (S87). Specifically, the average read response time can be determined by dividing the total read time by the number of read accesses. Similarly, the average write response time can be determined by dividing the total write time by the number of write accesses.

FIG. 29 is a flowchart of the processing for creating a reallocation plan. In the first example, data is reallocated for each virtual area by executing this reallocation process. Alternatively, in this example, since the time required for batch processing is estimated, data reallocation is simulated beforehand. The user is notified in a case where this simulation results in a determination that it will not be possible to meet the time limit.

In this example, data reallocation is simulated within the range necessary for computing the estimated time required for batch processing. That is, only the reallocation of the respective data used by the application program that executes a high-priority transaction process and the reallocation of the respective data used by the application program that executes a time-limited batch process are simulated. It is not necessary to simulate the reallocation of the respective data used by the other application program.

In this example, the ultimate reallocation destination of each virtual area is recorded in the reallocation destination determination result C335 of the virtual volume management information T33 (2). The result of the data reallocation simulation is recorded in the reallocation destination C338.

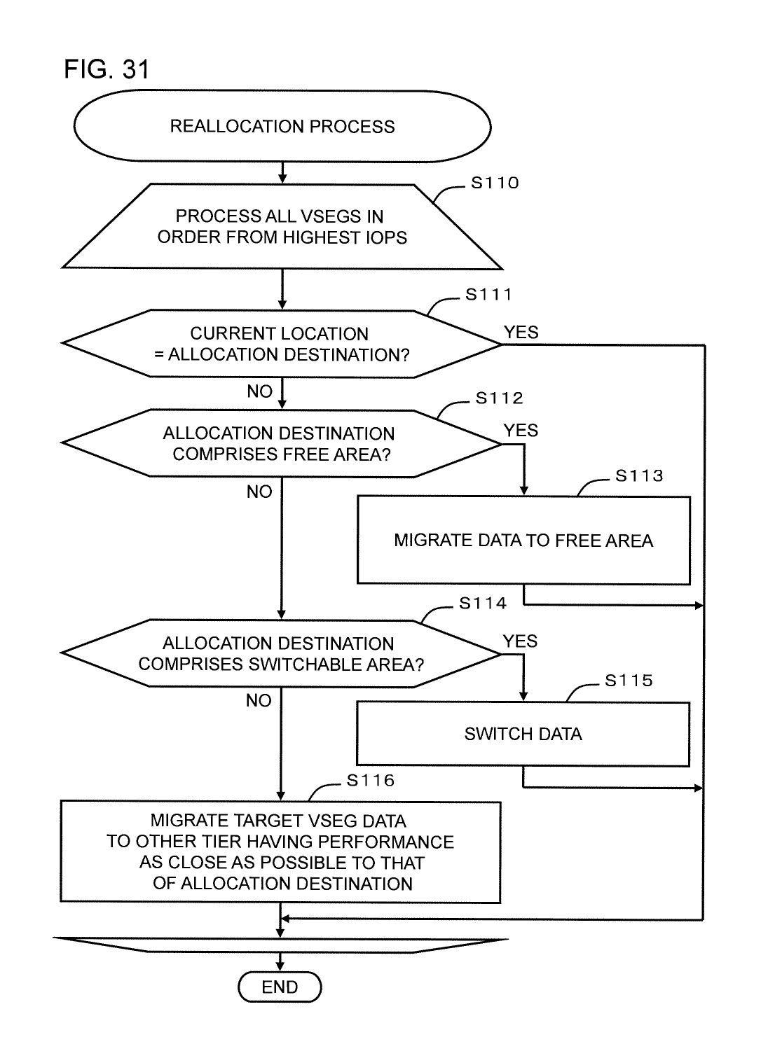

In this example, the reallocation planning process (FIG. 29), which is used for estimating the time required for batch processing, is not linked to the reallocation process (FIG. 31) for actually reallocating data between tiers. That is, a plan created by the reallocation planning process is only used for estimating the time required for batch processing. A reallocation destination is determined at the point in time when the data is actually to be reallocated with respect to each virtual area. In accordance with this, the process for creating a reallocation plan and the reallocation process can be divided, making it possible to simplify the program configuration. However, the present invention is not limited to this, and the configuration may also be such that the reallocation planning process and the reallocation process are interlinked, and reallocation is carried out based on a reallocation plan created by the reallocation planning process.

The processing of FIG. 29 is executed by the configuration management program P30. For convenience sake, an explanation will be given by abbreviating the configuration management program P30 to the management program P30.

The management program P30 respectively deletes the value of the reallocation destination determination result C335 and the value of the reallocation destination C338 of the virtual volume management information T33 (2) (S90).

In addition, the management program P30 deletes the value of the number of free actual areas C304 of the tier management information T30 (2), and thereafter, detects the number of actual areas that have not been allocated to a virtual area, and enters this number in C304 (S90).

The management program P30 executes the processing of S92 with respect to all the application programs (S91). The management program P30, based on the number of accesses, determines the tier to which the data of a virtual area is to be allocated for each virtual area in all of the virtual volumes used by the target application program (S92). The determined tier ID is recorded in the reallocation destination determination result C335 of the virtual volume management information T33 (2).

Next, the management program P30 determines the reallocation destination of each virtual area used by the application program, which is a high-priority transaction process (S93). In S93, the processing of each virtual area used in the high-priority transaction process is carried out in order from the virtual area with the largest IOPS as follows.

(A1) The management program P30 determines whether or not the ID of the tier to which the data of the target virtual area currently belongs and the tier ID recorded in the reallocation destination determination result C335 match. In a case where these IDs match, the management program P30 moves to A2, and in a case where these IDs do not match, the management program P30 moves to A3. The tier recorded in the reallocation destination determination result C335 will be called the target tier here.
(A2) The management program P30 records the ID of the target tier in the reallocation destination C338 of the virtual volume management information T33 (2) with respect to the target virtual area.
(A3) The management program P30 refers to the tier management information T30 (2) and determines whether or not there is a free actual area in the target tier. In a case where a free actual area exists, the management program P30 moves to A4. In a case where a free actual area does not exist, the management program P30 moves to A5.
(A4) The management program P30 configures the target tier ID in the reallocation destination C338 with respect to the target virtual area. In addition, the management program P30 decrements by one the value of the number of free actual areas C304 related to the target tier ID in the tier management information T30 (2).
(A5) The management program P30 determines whether or not the tier recorded in the reallocation destination determination result C335 comprises a switchable actual area. In a case where an actual area is able to be switched, the management program P30 moves to A6. In a case where an actual area is not able to be switched, the management program P30 moves to A7.
(A6) The management program P30 configures the target tier ID in the reallocation destination C338 of the target virtual area with respect to the actual area corresponding to the target virtual area and a virtual area comprising the switchable actual area.
(A7) The management program P30 configures the ID of another tier having performance that is as close as possible to that of the target tier in the reallocation destination C338 with respect to the target virtual area. Specifically, the ID of the tier with the closest possible performance to that of the target tier of the tiers comprising a free actual area is configured in the reallocation destination C338 of the target virtual area.

The allocation destination of each virtual area being used in the high-priority transaction process can be simulated by repeating each of the steps A1 through A7 for each target virtual area.

Next, the management program P30 determined the reallocation destination of each virtual area used by the application program, which is a time-limited batch process (S94). In S94, the management program P30 processes each target virtual area in order from the virtual area with the highest average number of accesses (IOPS) C334 value as follows.

(B1) The management program P30 determines whether or not the ID of the tier to which the data of the target virtual area currently belongs and the ID of the highest level tier match. In a case where these IDs match, the management program P30 moves to B2, and in a case where these IDs do not match, the management program P30 moves to B3.
(B2) The management program P30 configures the ID of the highest level tier in the reallocation destination C338 with respect to the target virtual area.
(B3) The management program P30 determines whether or not there is a free actual area in a higher level tier than the tier in which the data of the target virtual area is currently allocated. In a case where a free actual area exists, the management program P30 moves to B4, and in a case where a free actual area does not exist, the management program P30 moves to B5.
(B4) The management program P30 configures the ID of the high-level tier in the reallocation destination C338 with respect to the target virtual area. In addition, the management program P30 decrements by one the value of the number of free actual areas C304 of this high-level tier in the tier management information T30 (2).
(B5) The management program P30 determines whether or not a switchable actual area exists in a higher level tier than the tier in which the data of the target virtual area is currently allocated. In a case where a switchable actual area exists, the management program P30 moves to B4, and in a case where a switchable actual area does not exist, the management program P30 moves to B6.
(B6) The management program P30 configures the ID of the target tier with the highest performance of the tiers comprising a free actual area in the reallocation destination C338, and decrements by one the value of the number of free actual areas C304 related to the configured tier ID.

The allocation destination of each virtual area being used in the time-limited batch process can be simulated by repeating each of the steps B1 through B6 for each target virtual area. Using the above simulation result, the management program P30 estimates the time required for batch processing.

FIG. 30 is a flowchart showing the processing for estimating the time required for batch processing. The management program P30 estimates the time required to complete batch processing from the information in the number of read accesses C336 and the number of write accesses C337 of the virtual volume management information T33 (2) and the information of the average read response time and the average write response time of the tier management information T30 (2) of the management server side.

The management program P30 deletes the value of the estimated time required C352 of the batch process definition information T35 (2) (S100). The management program P30 carries out the processing of S102 with respect to all the application programs that have a time limit, which are registered in the batch process definition information T35 (2) (S101). The processing-target application program will be called the target application program.

The management program P30 estimates the time required from the start until completion of the processing of the target application program based on the average response time C303 of the respective actual areas corresponding to the respective virtual areas and the number of accesses C334 of the respective virtual area used by the target application program (S102).

For example, the management program P30 multiplies the average read response time of the tier to which the actual area corresponding to the virtual area belongs by the number of read accesses C336 of this virtual area. Similarly, the management program P30 multiplies the average write response time of the tier to which the actual area corresponding to the virtual area belongs by the number of write accesses C337 of this virtual area (=number of write accesses×average write response time). The management program P30 computes with respect to each virtual area to be used by the time-limited batch process a total value of the time required for read (=number of read accesses×average read response time) and the time required for write (=number of write accesses×average write response time). The management program P30 treats the value obtained by adding together all of the total values computed for each of the virtual areas as the estimated time required TP of the application program that is to perform the relevant batch process, and writes this value to the estimated time required C352 of the batch process definition information T35 (2).

The management program P30 determines whether or not there is an application program for which the processing completion time is likely to exceed the stipulated time limit among the application programs that are carrying out time-limited batch processes (S103). Specifically, the management program P30, in a case where a time, which adds an estimated time required TP to the processing start time of an application program that carries out batch processing, exceeds the completion time stipulated by a time limit TL, determines that this application program is unable to meet the time limit.

The management program P30 ends this processing when a determination has been made that all the application programs executing time-limited batch processes are meeting this time limit. The management program P30 issues a warning to the user upon discovering an application program that has been determined unable to meet the time limit (S104).

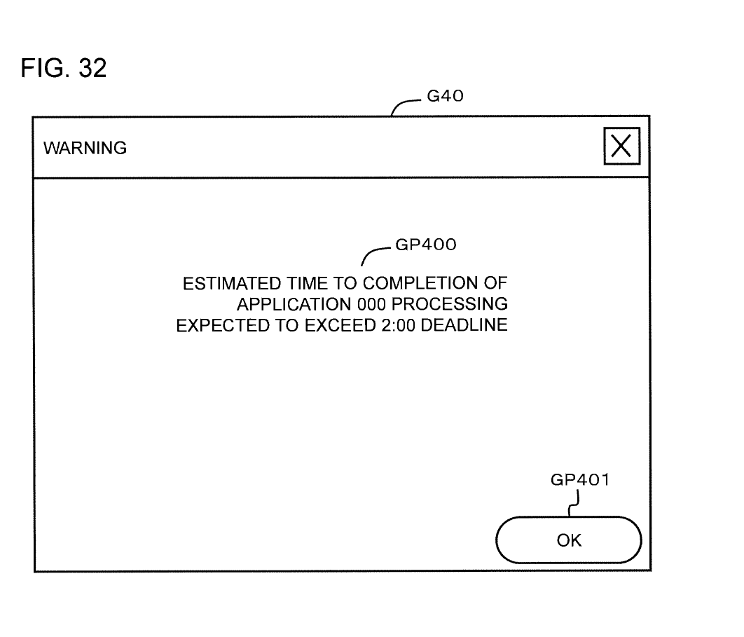

FIG. 32 is an example of a warning screen G40. The warning screen G40, for example, comprises a message display part GP400 and an OK button GP401. The user, who has checked the warning message, is able to cancel the screen G40 by operating the OK button GP401.

Furthermore, the configuration may be such that the user is notified only in a case where it is not possible to meet the time limit, or the configuration may be such that the user is notified of the estimation result (the result of an estimate as to whether or not it will be possible to meet the time limit) with respect to each batch process.

FIG. 31 is a flowchart showing data reallocation processing in accordance with this example. The reallocation process according to this example revises the actual area allocated to each virtual area in accordance with the reallocation plan (the reallocation destination determination result C335 of the management server-side virtual volume management information T33 (2)) created using the reallocation planning process (FIG. 29).

The reallocation program P302 executes the processing of S111 through S116 with respect to all of the virtual areas belonging to each virtual volume that is used by each application program (S110). The reallocation program P302 processes the respective virtual areas in order from the virtual area having the highest IOPS.

The reallocation program P302 determines whether or not the ID of the tier corresponding to the actual area currently allocated to the target virtual area matches the value of the reallocation destination determination result C335 corresponding to the target virtual area (S111). Hereinafter, the tier comprising the actual area currently allocated to the target virtual area may be called the allocation-source tier. The tier registered in the reallocation destination determination result may be called the reallocation-destination tier.

In a case where the ID of the allocation-source tier associated with the target virtual area and the reallocation-destination tier ID match (S111: YES), this processing ends.

In a case where the ID of the allocation-source tier associated with the target virtual area and the reallocation-destination tier ID do not match (S111: NO), the reallocation program 2302 determines whether or not there is a free actual area in the reallocation-destination tier (S112).

In a case where a free actual area exists in the reallocation-destination tier (S112: YES), the processing proceeds to S113. In a case where a free actual area does not exist in the reallocation-destination tier (S112: NO), the processing moves to S114.

S113 will be explained. The reallocation program P302 allocates an unused actual area in the reallocation-destination tier to the target virtual area in place of the currently allocated actual area (S113). The actual area that belongs to the allocation-source tier is the data migration-source actual area. For convenience sake, this actual area may be called the migration-source actual area. The unused actual area that belongs to the reallocation-destination tier is the data migration-destination actual area. For convenience sake, this actual area may be called the migration-destination actual area.

The reallocation program P302 updates the value of the actual area ID C333 corresponding to the target virtual area in the virtual volume management information T33 to the ID of the migration-destination actual area. The reallocation program P302 instructs the storage apparatus 20 to migrate data from the migration-source actual area to the migration-destination actual area.

The storage control program P20 of the storage apparatus 20, upon receiving the instruction from the reallocation program P302, migrates the data from the migration-source actual area to the migration-destination actual area.

S114 will be explained. The reallocation program P302 determines whether or not an actual area that is able to switch data with the actual area allocated to the target virtual area exists in the reallocation-destination tier (S114).

In a case where a switchable actual area exists (S114: YES), the processing proceeds to S115. In a case where a switchable actual area does not exist (S114: NO), the processing moves to S116.

S115 will be explained. The reallocation program P302 switches the allocation status with respect to the virtual area of the actual area allocated to the target virtual area (hereinafter, the switch-source actual area) with the allocated actual area of the reallocation-destination tier (hereinafter, the switch-destination actual area) (S115).

The reallocation program P302 instructs the storage apparatus 20 to switch the data between the switch-source actual area and the switch-destination actual area. The storage control program P20 of the storage apparatus 20, upon receiving the instruction from the reallocation program P302, switches the data between the specified actual areas.

Configuring this example like this achieves the same effect as the first example. In addition, in this example, a determination is made as to whether or not the application program, which executes a time-limited batch process, is able to meet this time limit, and the result thereof can be notified to the user. Consequently, user usability is improved.

### Example 3

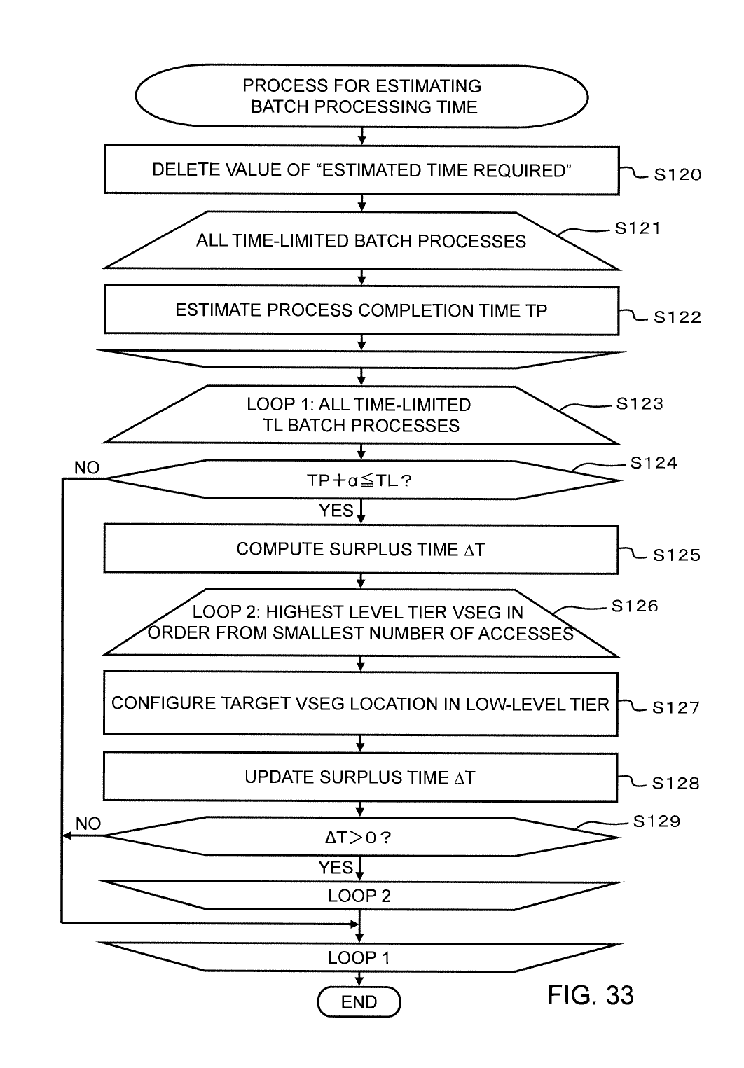

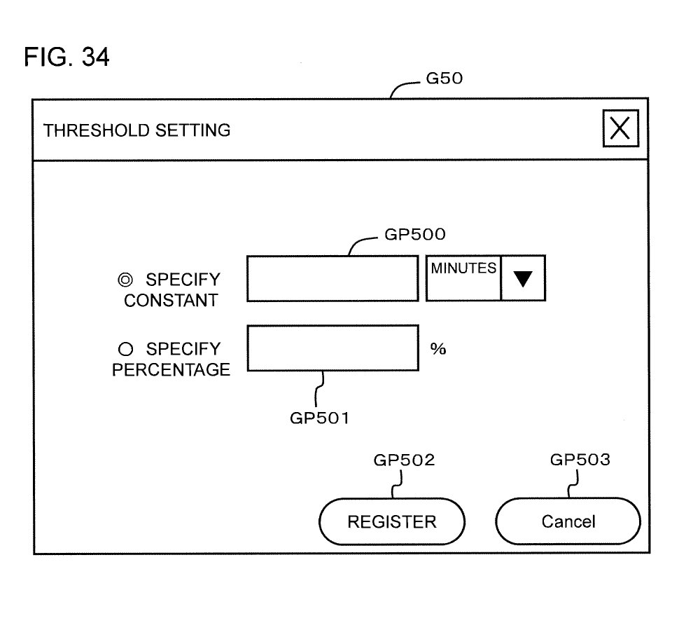

A third example will be explained by referring to FIGS. 33 and 34. In this example, as described in the second example, an estimate is made of the time required to complete the processing of the application program that executes a time-limited batch process. In addition, in this example, in a case where the estimated time required TP is shorter by a prescribed period of time than the time limit TL, the high-level tier actual area that had been allocated to this application program is allocated to the other application program. The explanation below will focus on the differences with either the first example or the second example.

FIG. 33 is a flowchart showing the processing for estimating batch processing time. The configuration management program P30 (hereinafter, the management program P30) deletes the value of the estimated time required C352 in the batch process definition information T35 (2) the same as was described using FIG. 30 (S120).

Next, the management program P30 carries out the processing of S122 with respect to all the application programs with a time limit registered in the batch process definition information T35 (2) (S121)

The management program P30, based on the number of accesses C334 to the respective virtual areas used by the target application program and the average response time C303 of the respective actual areas corresponding to the respective virtual areas, estimates the time required from the start until the completion of the processing of the target application program (S122). Since the details of this operation were described using S102 of FIG. 30, these details will be omitted.

The management program P30 executes steps S124 through S129 with respect to all the application programs that will execute the time-limited batch process (S123).

The management program P30 determines whether a value which has added a prescribed time α to the estimated time required TL of the target application program is equal to or smaller than the time limit TL (S124). That is, the management program P30 determines whether or not the estimated time required TP for the batch process will be faster by a fixed time period or longer than the time limit TL (TP+α≦TL).

The fixed time α value is provided in advance by the management program P30. A “fixed time period” is the threshold of a time range. The time range threshold, for example, may be configured as a constant, such as either 30 minutes or one hour, or may be configured as a percentage of the entire time range.

For example, in a case where the start time is 0:00 AM, the deadline for completion is 5:00 AM, and the fixed time period is stipulated as 10 percent of the entire time range, the fixed time period will be 30 minutes. In addition, the configuration may be such that the user is able to manually configure a “fixed time period” using a setting screen G50.

FIG. 34 is an example of the screen G50 for stipulating a fixed time period. The setting screen G50, for example, comprises a constant specification part GP500, a percentage specification part GP501, a register button GP502, and a cancel button GP503.

For example, in a case where a fixed value, like 30 minutes or one hour, is to be specified, the user inputs a numeral like either “30” or “1” in the constant specification part GP500. The unit can be changed at will. Alternatively, in a case where a fixed percentage such as 10% or 20% is to be specified, the user inputs a percentage like “10” or “20” in the percentage specification part GP501.

Return to FIG. 33. In a case where the estimated time required for batch processing is not faster than the fixed time period or longer (S124: NO), an application program that will execute a batch process with another time limit is treated as the target application program, and the processing returns to S123.

In a case where it has been determined that the estimated time required for batch processing is faster by a fixed time period or longer than the time limit (S124: YES), the management program P30 computes the surplus time ΔT for the target batch process (S125)

The surplus time is the difference between a time that is faster by a fixed time period α than the deadline for the batch processing and the estimated completion time of this batch processing. As used here, the estimated completion time is the time from the start of the batch processing at which the estimated time required TP lapses. That is, the surplus time indicates how much of a time margin there is with respect to the batch processing deadline.

The management program P30 executes steps S127, S128 and S129 in order from the virtual area with the smallest number of accesses with respect to all the virtual areas for which the ID of the highest level tier is configured in the reallocation destination determination result C335 of the virtual volume management information T33 (2) from among the virtual areas to be used by the target application program. The number of accesses is the total value of the number of read accesses C336 and the number of write accesses C337 of the virtual volume management information T33 (2).

The management program P30 reconfigures the reallocation destination C338 of the target virtual volume to the ID of the low-level tier comprising an unallocated actual area (S127). In a case where the low-level tier does not have an unallocated actual area, the management program P30 reconfigures the ID of the tier to which the actual area corresponding to the switchable virtual area belongs to the reallocation destination C338 of the target virtual area, and reconfigures the ID of the highest level tier to the reallocation destination C338 of the switchable virtual area.

The switchable virtual area, specifically, is the same as that of S44. However, in this example, the definition of the reallocation destination is not based on the value of the reallocation destination determination result C335, but rather is based on the value of the reallocation destination C338.

The management program P30 updates the value of the surplus time (S128). The management program P30 updates the value of the surplus time of the batch processing based on the change of the data reallocation destination with respect to the target virtual area.

Specifically, the management program P30 multiplies the number of read accesses C336 of the target virtual area by the difference ΔRTr between the average read response time RTr1 in the reallocation destination tier of the target virtual area and the average read response time RTr2 of the highest level tier. This value will be called the read surplus time (=value of ΔRTr×C336).

Similarly, the management program P30 multiplies the number of write accesses C337 of the target virtual area by the difference ΔRTw between the average write response time RTw1 in the reallocation destination tier of the target virtual area and the average write response time RTw2 of the highest level tier. This value will be called the write surplus time (=value of ΔRTw×C337).

The management program P30 computes a new surplus time ΔT by subtracting the read surplus time and the write surplus time from the surplus time ΔT computed in S125 as shown in the formula 1 below (S128).

ΔT=ΔT−(RTr1−RTr2)×number of read accesses−(RTw1−RTw2)×number of write accesses (Formula 1)

The management program P30 determines whether or not the surplus time ΔT determined using Formula 1 is larger than 0 (S129). In a case where the surplus time ΔT is larger than 0 (S129: YES), the management program P30 makes another virtual area the target virtual area and returns to S126.

In a case where the surplus time ΔT is equal to or less than 0 (S129: NO), the processing exits the second loop.

Configuring this example like this also achieves the same effects as the first example and the second example. In addition, in this example, in a case where it has been estimated that the batch processing will end earlier by a fixed time or longer, the actual area of the high-level tier that has been allocated to the batch processing is allocated to the other application program. Consequently, in this example, it is possible to use the high-level tier actual area more efficiently.

### Example 4

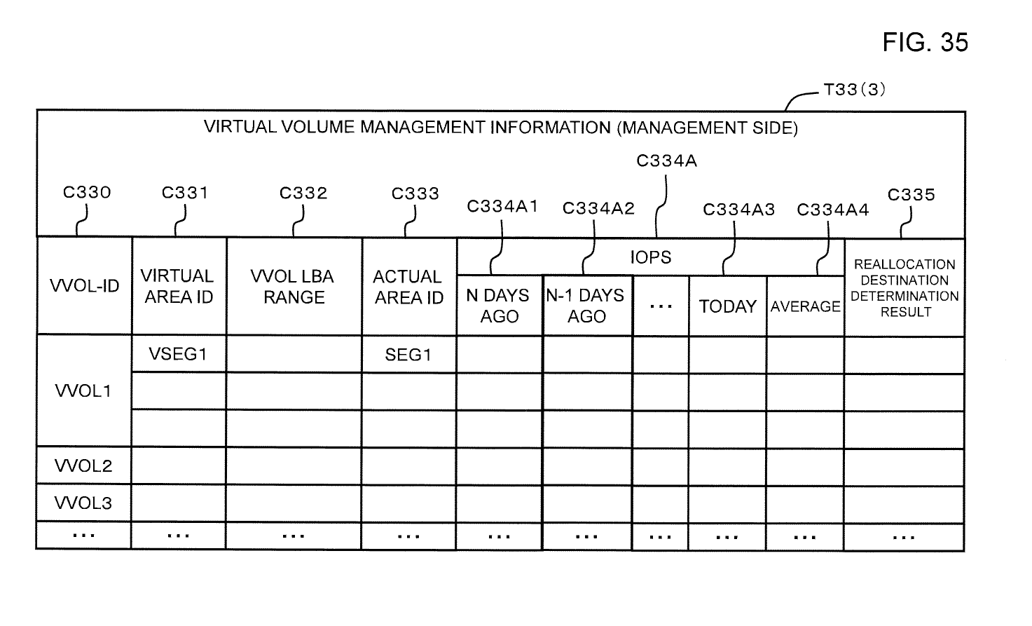

A fourth example will be explained by referring to FIGS. 35 through 37. In this example, the history of the number of accesses with respect to each virtual area is only stored for a prescribed number of days, and the configuration management program P30 determines the data reallocation destination of the virtual area based on the prescribed days worth of number of accesses historical data.

In accordance with this, it is possible to more appropriately determine the data reallocation destination even in a case where there is a long-term trend of accesses to the virtual area by the application program. A long-term access trend, for example, is a weekly or daily I/O access trend.

Using a relatively long history of number of accesses makes it possible to prevent the determination of the data reallocation destination from being influenced by either short-term or temporary changes in I/O access frequency.

Determining the data reallocation destination more appropriately enables a high access frequency area to be allocated to a high-performance tier, thereby making it possible to enhance the performance of the storage apparatus. The following explanation will focus on the differences with the respective examples described above.

FIG. 35 is an example of virtual volume management information T33 (3) according to this example. The virtual volume management information T33 (3) of this example comprises items C330 through C333 and C335, which are shared in common with the virtual volume management information T33 shown in FIG. 10. In addition, the virtual volume management information T33 (3) of this example comprises a prescribed number of days worth of IOPS history C334A in place of the IOPS C334 shown in FIG. 10.

The IOPS history C334A is an item that manages a preconfigured prescribed number of days N worth of IOPS in units of days. An average value of the IOPS for the prescribed number of days can also be recorded in the IOPS history 334A.

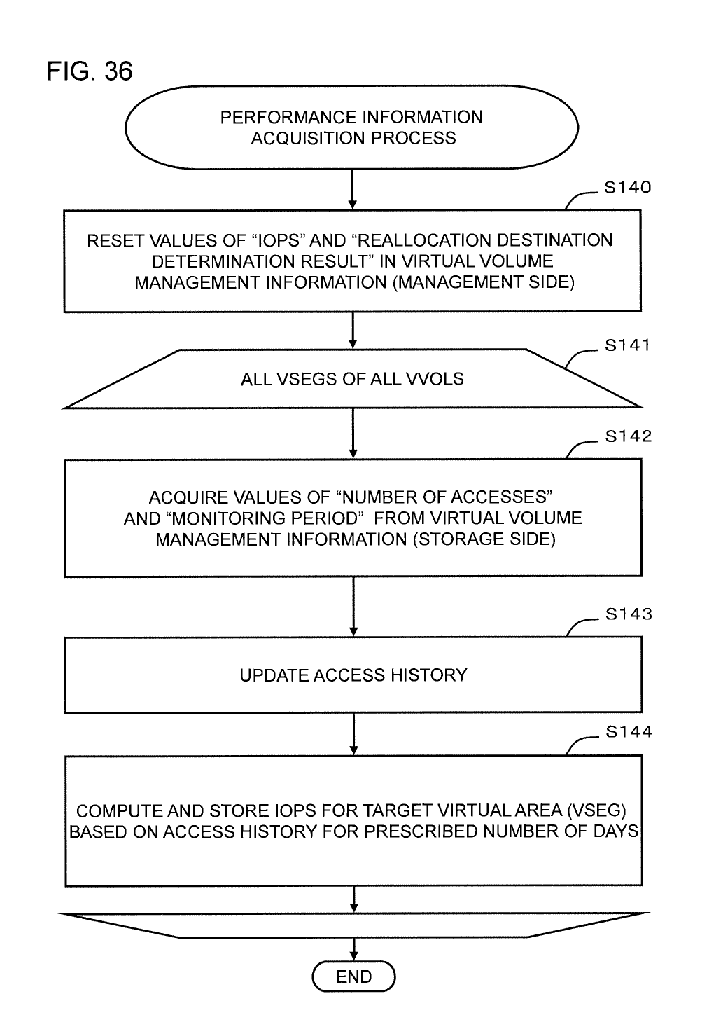

FIG. 36 is a flowchart showing a performance information acquisition process. This process is executed by the performance information acquisition processing program P301. In this explanation, the performance information acquisition processing program P301 will be called the information acquisition program P301.

The information acquisition program P301 deletes all the data of the virtual volume management information T33 (3) IOPS C334A and all the data of the reallocation destination determination result C335 stored in the management server 30 (S140).

The information acquisition program P301 executes the respective processing of S142, S143 and S144 with respect to all the virtual areas 221 of all of the virtual volumes 220 (S141).

The configuration management program P30 acquires the value of the number of accesses C224 and the value of the monitoring period C225 corresponding to the target virtual area from the virtual volume management information T22 stored in the storage apparatus 20 (S142).

The information acquisition program P301 uses the data acquired from the storage apparatus 20 to update the IOPS history 334A of the virtual volume management information T33 (3) (S143). That is, the information acquisition program P301 clears the value of the C334A1 of N days ago in the virtual volume management information T33 (3), and moves the values of the remaining access histories one day to the left, respectively. For example, the information acquisition program P301 moves the value recorded in N−1 days ago C334A2 to the N days ago C334A1. The same holds true for the other values.

In addition, the information acquisition program P301 records the number of accesses acquired from the storage apparatus 20 in a number of accesses for today C334A3 in the virtual volume management information T33 (3).

The information acquisition program P301, based on a prescribed N-days worth of access history data, computes a value for the number of accesses per unit of time (IOPS), and records this value in the average value C334A4 of the virtual volume management information T33 (3).

The value for the number of days N to be stored in the access history either can be provided beforehand by the configuration management program P30, or can be configured by the user via the setting screen.

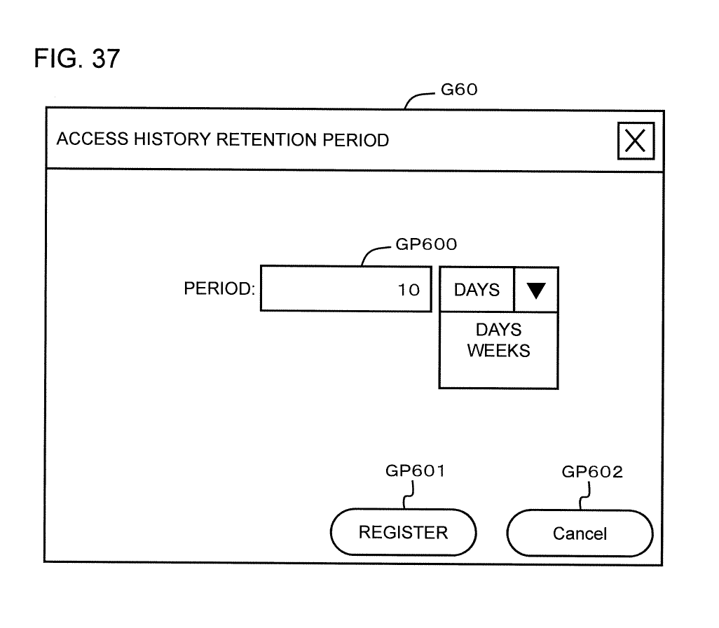

FIG. 37 shows a screen G60 for configuring an access history retention period. The screen G60, for example, comprises a retention period specification part GP600 for specifying a retention period, a register button GP601, and a cancel button GP602. The user can specify a retention period, for example, in either “day (s)” or “day (s) of the week” units. The longer the retention period of the access history, the more storage areas are needed for storing the access history.

Configuring this example like this also achieves the same effects as the first example. In addition, in this example, it is possible to store a relatively long access history, and to determine a data reallocation destination based on this access history. Consequently, in a case where the access trend of an application program changes over a long period of time, the data being used by this application program can be allocated to an appropriate tier.

### Example 5

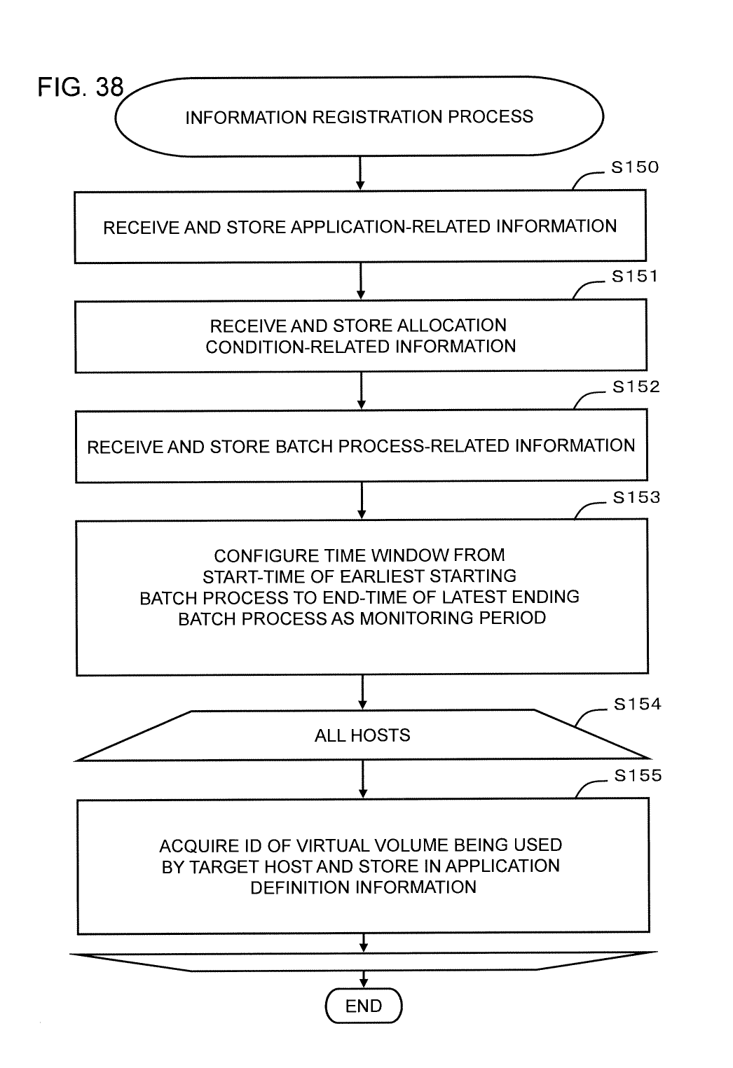

A fifth example will be explained by referring to FIG. 38. In this example, a virtual area data reallocation destination can be determined based on a number of accesses to a virtual area during the time that batch processing is being carried out.

This makes it possible to determine a more appropriate data reallocation destination even in a case where the access trend by an application program that will carry out a transaction process will differ greatly in accordance with whether a batch process is being carried out or a batch process is not being carried out.

A case where access trends differ greatly, for example, is one in which the number of I/O accesses of a transaction process during the time window when a batch process is being carried out is either significantly larger or significantly smaller than the number of I/O accesses of a transaction process during the time window when a batch process is not being carried out.

For this reason, in this example, the I/O processing efficiency of the storage apparatus is enhanced during the time window when a batch process is being carried out by carrying out a reallocation based on the frequency of I/O accesses with respect to the virtual area during the time window when the batch process is being carried out.

FIG. 38 is a flowchart showing the processing for registering input information in accordance with this example. The flowchart shown in FIG. 38 comprises steps S150 through S152, S154 and S155, which correspond to S10 through S14 of the flowchart described using FIG. 14.

The input information registration processing program P300 stores information inputted by the user in the relevant items of the application definition information T34 (S150). The registration program P300 receives a data allocation condition for each tier 211 as the input information from the user, and stores these conditions in the item C302 corresponding to the tier management information T30 (S151).

The registration program P300, for example, receives information related to an application program that will execute a time-limited batch process as the input information from the user, and stores this information in the batch process definition information T35 (S152).

The registration program P300 identifies the application program with the earliest start-time and the application with the latest end-time from among the application programs carrying out batch processes that are registered in the batch process definition information T35.

The registration program P300 acquires the earliest start-time and the latest end-time from the identified application programs, and configures these times in the monitoring period C225 of the virtual volume management information T22 of the storage apparatus 20. The earliest start-time becomes the beginning of the monitoring period, and the latest end-time becomes the end of the monitoring period.

Furthermore, the management server 30 configures the beginning and the end of the monitoring period C225 in the virtual volume management information T22 inside the storage apparatus 20 by way of the management communication network CN2.

The registration program P300 carries out the processing of S154 with respect to all of the hosts that are running an application program (S153). The registration program P300 acquires from the target host the identifier of the virtual volume that will be used by the target host, and stores this identifier in the application definition information T34 (S154).

Configuring this example like this also achieves the same effects as the first example. In addition, in this example, it is possible to allocate the data of the virtual area being used in a transaction process to the appropriate tier even in a case where the presence or absence of the execution of a batch process affects the trend of the number of I/O accesses in accordance with the transaction process.

### Example 6

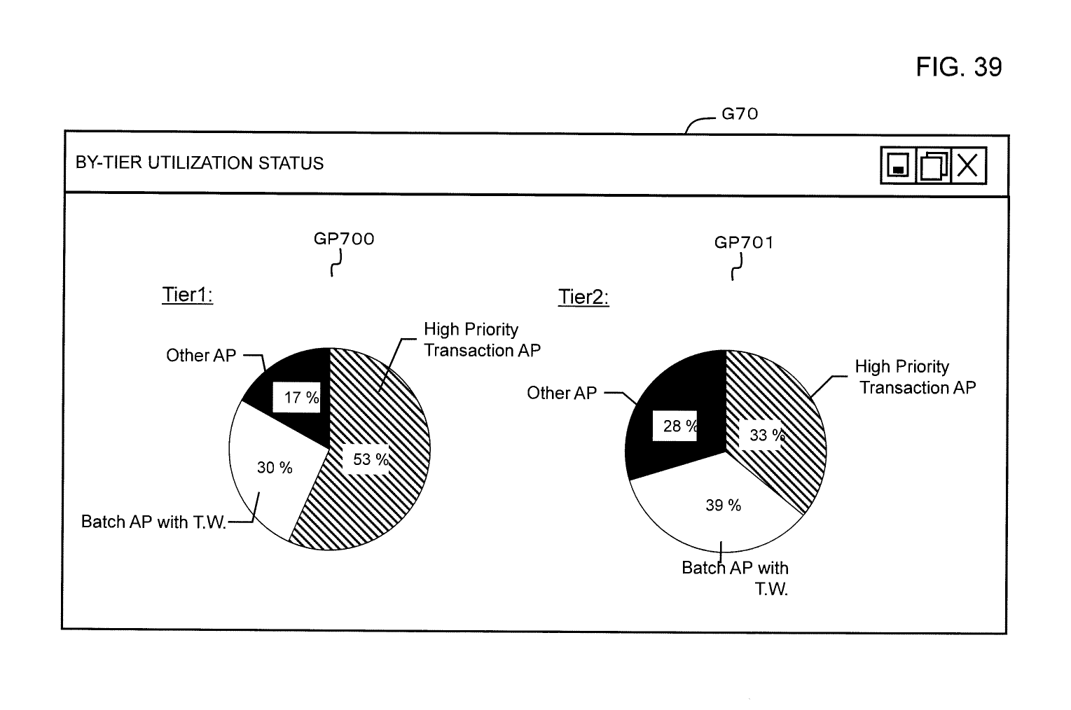

A sixth example will be explained by referring to FIG. 39. In this example, utilization statuses are displayed by tier on a management terminal 40 screen.

FIG. 39 is an example of a screen G70 showing utilization statuses by tier. The screen G70, for example, comprises a utilization status display part GP700 and GP701 for each tier. The one display part GP700, for example, corresponds to the high-level tier 211A. The other display part GP701, for example, corresponds to the mid-level tier 211B. Although omitted from FIG. 39, a display part corresponding to the low-level tier may also be disposed in the screen G70.

Each display part GP700, GP701 displays a graph of the percentage of actual areas of the tier that are being used by each application program.

This example also achieves the same effects as the first example. In addition, in this example, it is possible to display the actual area utilization status in accordance with each application program on a tier-by-tier basis. Consequently, the user is able to easily discern the percentage of actual areas being used by a high-priority transaction process and the percentage of actual areas being used by a time-limited batch process for each tier. This enables the user to readily make a determination as to whether or not to add a storage device 27 to each tier 211, thereby enhancing user usability.

### Example 7

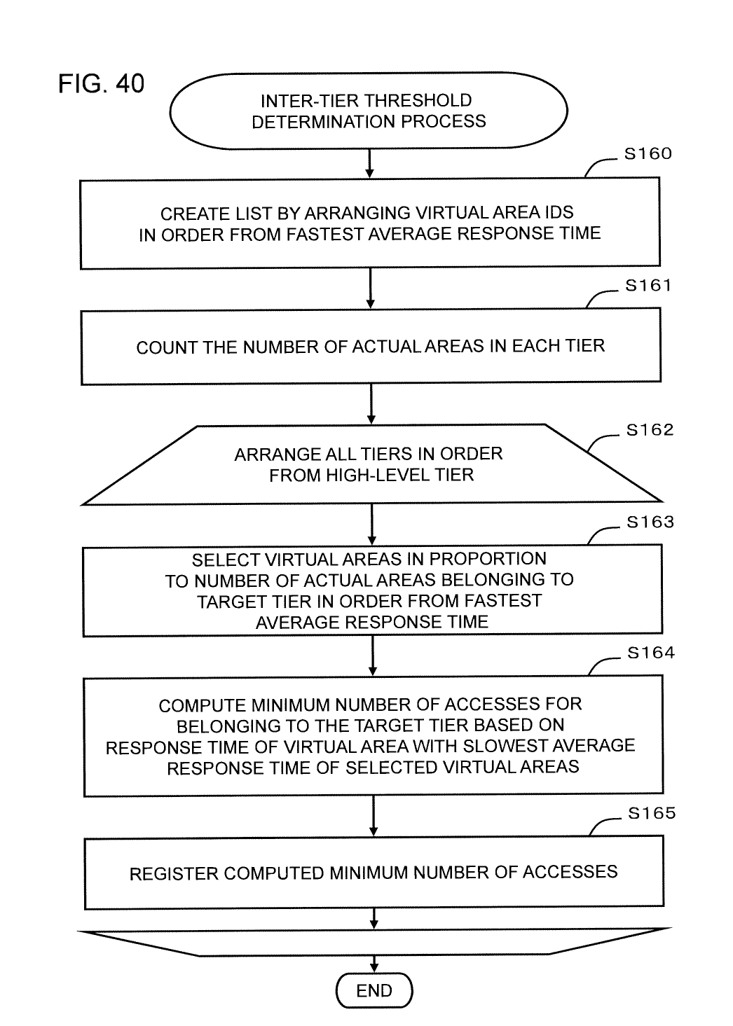

A seventh example will be explained by referring to FIG. 40. In this example, it is possible to determine and dynamically change the range of the allowable number of tier accesses (the allocation condition with respect to the tier), which is used to determine the data reallocation destination of a virtual area, in accordance with a storage apparatus 20 I/O performance actual results value.

As used here, “dynamically change” signifies the ability to make a change in accordance with the status of the system without using a fixed value predetermined by the system and so forth. An I/O performance actual results value is a value that is actually measured while operating the system. This is not I/O performance that is assumed from either the specifications or configuration, or either the hardware or the software.

The configuration management program P30 according to this example executes an inter-tier threshold determination process (FIG. 40), which will be described below.

Although omitted from the drawing, the storage-side virtual volume management information T22 of this example also manages a total response time, which shows the total of the read request response time and the write request response time in addition to the configuration described in the first example. Consequently, for example, the total response time item may be created by consolidating the total read time C227 and the total write time C228 shown in FIG. 24.

Although not shown in the drawing, the management-side virtual volume management information T33 of this example also manages an average response time in addition to the configuration described in the first example. The average response time is an average value of either the time required for the read processes or the time required for the write processes of the storage apparatus 20 with respect to an I/O access request from the host.

Although omitted from the drawing, the tier management information T30 of this example also manages a total number of the actual areas of each tier in addition to the configuration described in the first example.

Although omitted from the drawing, the performance information acquisition process of this example carries out processing similar to the processing described using FIG. 18. Accordingly, the new points will be explained by referring to FIG. 18. In this example, in S22, a value of a total response time is acquired from the virtual volume management information T22 of the storage side in addition to the number of accesses and the monitoring period.

In this example, in S23, an average response time is computed together with computing the average number of accesses (IOPS). The average response time can be determined by dividing the total response time for each virtual area by the number of accesses to this virtual area.

In addition, in this example, the average number of accesses and the average response time are stored in the management server-side virtual volume management information T33 in S24.

FIG. 40 is a flowchart showing the processing for determining the condition for allocating data to each tier, that is, the processing for determining the range of the number of accesses that each tier allows. This process is executed by the configuration management program P30 (will be called the management program P30).

The management program P30 creates a list of virtual area IDs in order from the virtual area having the fastest average response time with respect to all the virtual areas registered in the virtual volume management information T33 (S160).

The management program P30 counts the number of actual areas belonging to each tier and configures a value in a “number of actual areas” in the tier management information T30 (S161).

The management program P30 executes the respective steps of S163, S164 and S165 hereinbelow in order from the high-level tier with respect to all the tiers registered in the tier management information T30 (S162).

The management program P30 selects from the list of virtual area IDs in order from the virtual area with the fastest average response time virtual area IDs in proportion to the number of actual areas of the target tier (S163). The management program P30 carries out the selection process from the virtual area with the fastest average response time, excluding a virtual area that had already been selected in the loop that began from S162.

The management program P30 acquires the average response time of the virtual areas corresponding to the selected virtual area IDs, and based on the value of a fastest average response time, computes the lower limit value of the range of the number of accesses allowed by the target tier (IOPS) (S164). The value of the IOPS, which constitutes the lower limit value of the range of the number of accesses allowed by the target tier, is determined by dividing this unit of time by the value of the fastest average response time.

The management program P30 configures in the tier management information T30 the range of the number of accesses allowed by the target tier, from the IOPS value computed in S164 to the value of the IOPS that is the lower limit value of the tier located one level above the target tier (S165).

Configuring this example like this also achieves the same effects as the first example. In addition, in this example, it is possible to dynamically configure in accordance with the actual operating status of the storage apparatus 20 a condition (a range of allowable number of accesses) for allocating data between tiers. Consequently, virtual area data can be reallocated to a more appropriate tier.

### Example 8

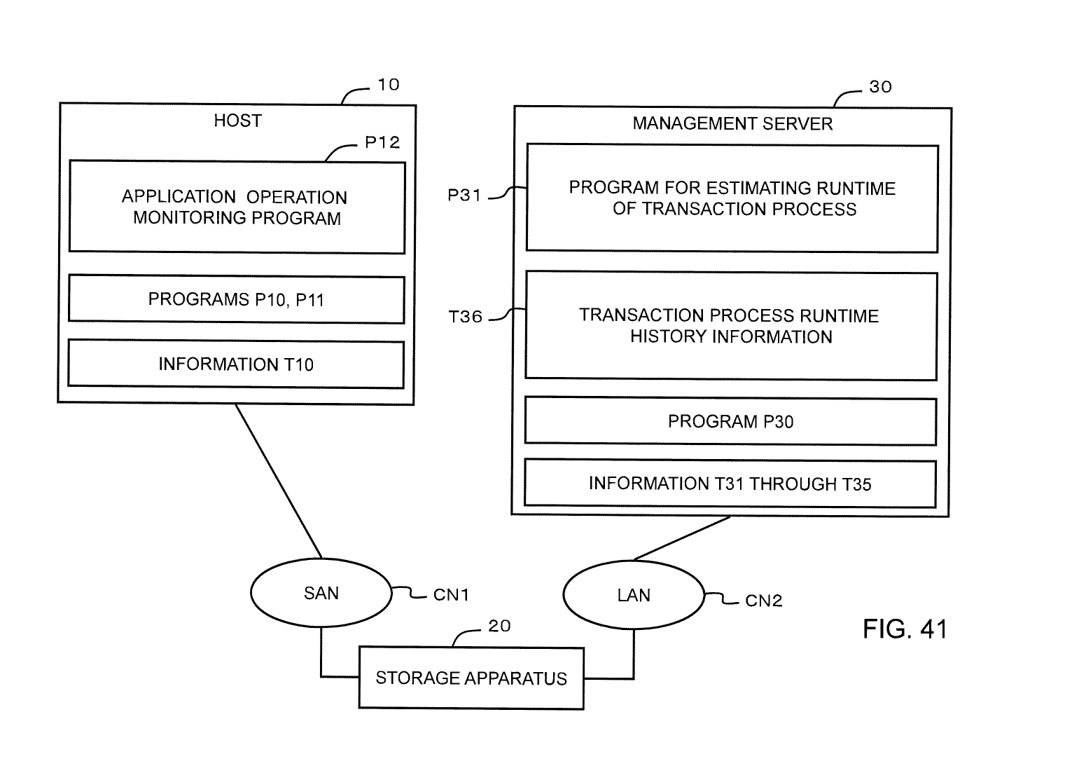

An eighth example will be explained by referring to FIGS. 41 through 44. In this example, it is possible to start a time-limited batch process after the passage of a fixed time period following the end of a high-priority transaction process.

FIG. 41 shows an overview of the entire configuration of a computer system according to this example. An application operation monitoring program P12 for monitoring the operating status of the application program P10 is disposed anew in the host 10 in this example.

The application operation monitoring program P12 monitors the start and end (or termination) of the application program running on the target host 10, and acquires the start-time and the end-(termination) time. In this example, the end-time of the application program includes the termination time of the application program.

The application operation monitoring program P12 sends to the management server 30 the start-time and the end-time of the application program P10 in accordance with a query from the management server 30.

A program P31 for estimating the runtime of the application program executing a transaction process and information T36 which stores a history and the like of the runtime by the application program executing the transaction process are newly disposed in the management server 30 of this example. Hereinafter, the program P31 will be called the runtime estimation program P31. The information T36 will be called the runtime history information T36.

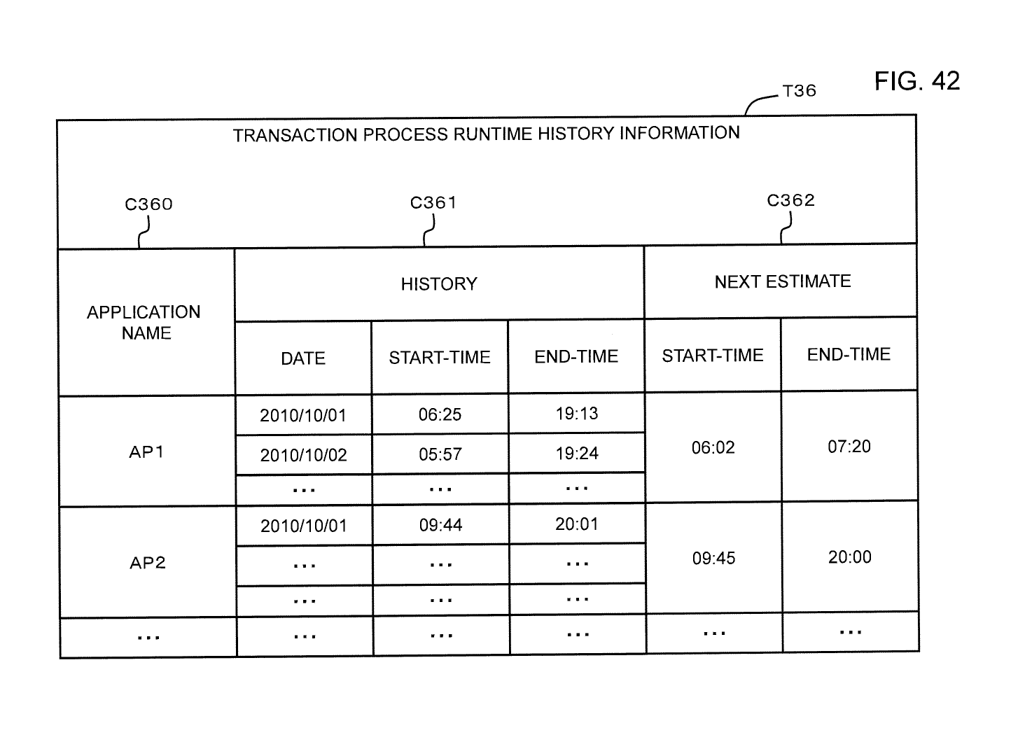

FIG. 42 shows an example of the runtime history information T36. The runtime history information T36 holds the runtime and so forth of the application program that is executing a high-priority transaction process. The runtime history information T36 does not need to manage the runtime and so forth of a low-priority transaction process.

The runtime history information T36, for example, can comprise an application name C360, a history C361, and a next estimate C362. A name for identifying the application program that is executing the high-priority transaction process is configured in the application name C360.

The history C361 also includes the sub-items “date”, “start-time” and “end-time”. The date, start-time and end-time when the high-priority transaction process was executed are recorded in the history C361.

The next estimate C362 also includes the sub-items “start-time” and “end-time”. An estimated start-time and an estimated end-time related to the next execution of the high-priority transaction process are recorded in the next estimate C362.

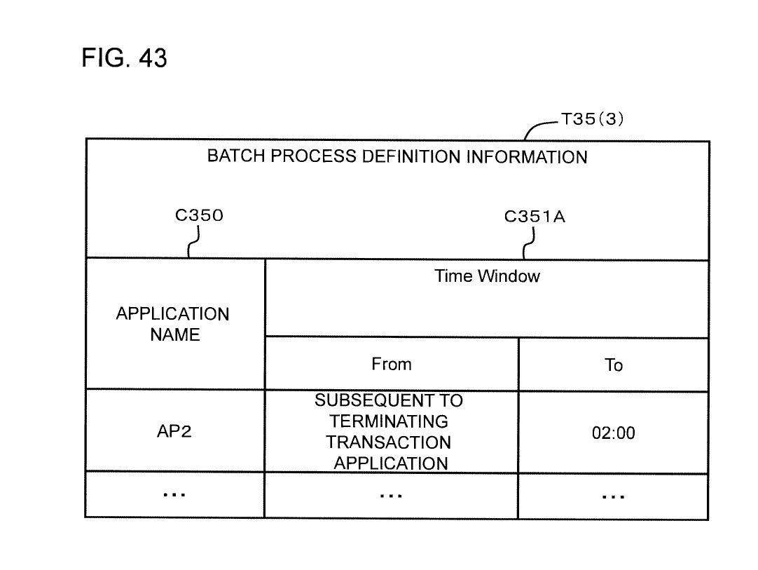

FIG. 43 shows batch process definition information T35 (3). “Subsequent to terminating application program executing transaction program” can be configured as the value of the time window C351A in the batch process definition information T35 (3) of this example.

When “subsequent to terminating application program executing transaction program” is configured as the earliest time that a batch process can be started, this batch process is executed after a fixed time period has elapsed since the execution of the application that carried out the high-priority transaction process ends.

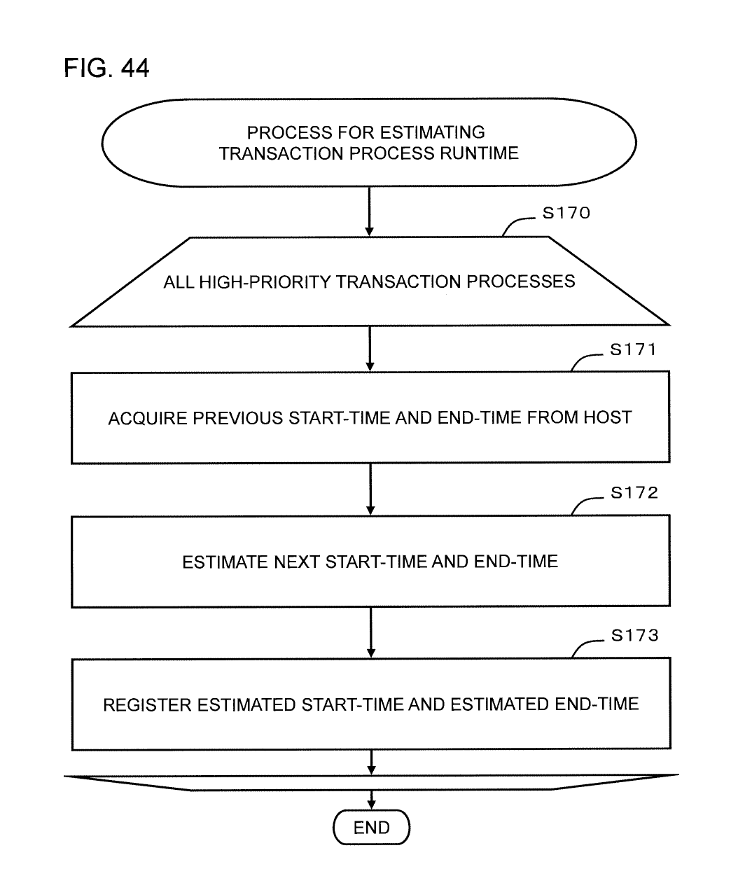

FIG. 44 is a flowchart showing the processing details of the runtime estimation program P31. For the sake of convenience, the runtime estimation program P31 will be called the estimation program P31 here.

The estimation program P31 executes S171, S172 and S173 with respect to all applications, which have “high” configured as the priority and, in addition, have “transaction” as the application type (S170).

The estimation program P31 acquires the previous operation start-time and operation termination time of the target application program from the host 10, and registers these times in the history C361 of the runtime history information T36 (S171).

The estimation program P31 estimates both the next operation start-time and operation end-time based on the data recorded in the operation history C361 of the target application program (S172). Various estimation methods are possible, but, for example, an average value of past start-times may be determined as the estimated start-time, and an average value of past end-times may be determined as the estimated end-time.

The estimation program P31 registers the estimated start-time and end-time in the next estimate C362 of the runtime history information T36 (S173).

Configuring this example like this also achieves the same effects as the first example. In addition, in this example, a batch process can be started after a fixed time period has elapsed following the end of a high-priority transaction process. Consequently, it is possible the prevent the load on the system from increasing as a result of a batch process being started during the period when a high-priority transaction process is running, thereby enabling transaction processing to end relatively quickly.

### Example 9

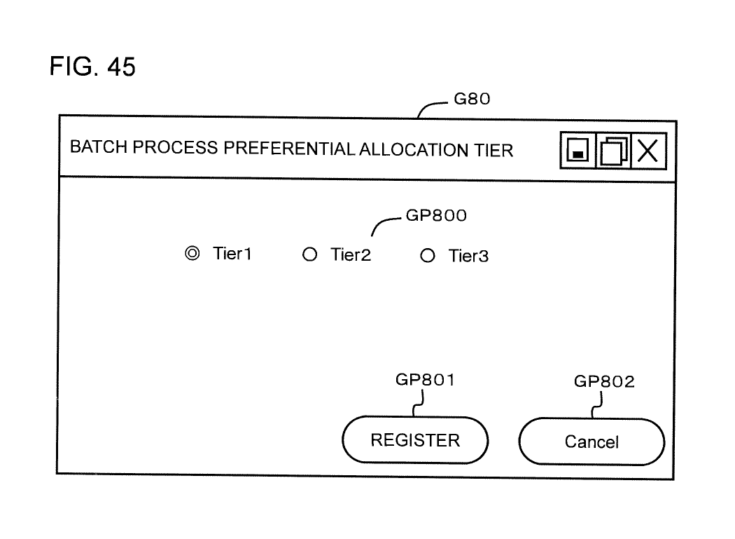

A ninth example will be explained by referring to FIG. 45. In this example, the user is able to configure a tier that preferentially allocates an actual area to a virtual area to be used by a time-limited batch process.

FIG. 45 shows a screen G80 for configuring beforehand a tier for preferentially allocating an actual area to a virtual area to be used by a batch process.

The screen G80 comprises a tier selection part GP800 for selecting a tier, a register button GP801, and a cancel button GP802. In the tier selection part GP800, it is possible to select any one of the tiers 211 of the storage apparatus 20. When the user selects a desired tier and presses the register button GP801, the selected tier is registered in the management server 30. Information indicating which tier is to be preferentially allocated to the batch process (hereinafter, preferred tier information), for example, is stored in the auxiliary storage apparatus 33 of the management server 30.

Although omitted from the drawing, in the input information registration process of this example, the information acquisition program P301 acquires and stores the preferred tier information from the management terminal 40. The steps for acquiring and storing this preferred tier information, for example, may be executed between S12 and S13 of FIG. 12.

Although omitted from the drawing, in this example, a tier defined in the preferred tier information is preferentially used in a process for reallocating data of a virtual area to be used in accordance with a time-limited batch process.

Specifically, a flowchart for this example can be created by replacing “highest level tier” with “preferential use tier” in S51, S52 and S54 of the flowchart shown in FIG. 21.

Configuring this example like this also achieves the same effects as the first example. In addition, in this example, the user can configure a tier that preferentially allocates an actual area with respect to the data of a virtual area to be used in a time-limited batch process. Consequently, user usability is enhanced. For example, it is possible to prevent an actual area of a high-level tier from being allocated to a time-limited batch process, and to allocate the high-level tier actual area to a high-priority transaction process instead.

Furthermore, the present invention is not limited to the examples. A person having ordinary skill in the art will be able to make various additions and changes without departing from the scope of the present invention. For example, the present invention described hereinabove can be put into practice by arbitrarily combining the technical features.

### REFERENCE SIGNS LIST

10 Host computer
20 Storage apparatus
30 Management server
40 Management terminal
50 Management system
210 Pool
211 Tier
212 Actual area
220 Virtual volume
221 Virtual area

1. A management apparatus for managing a computer system, which comprises multiple host computers that run application programs and a storage apparatus that provides a virtual volume to the host computers,
wherein the storage apparatus comprises multiple pools comprising multiple storage tiers of respectively different performance, and
is configured so as to select an actual area from each of the storage tiers in accordance with a write access from each of the host computers, and to allocate this selected actual area to an access-target virtual area inside the write-accessed virtual volume from among the respective virtual volumes,
the computer system management apparatus comprising:
an allocation control part for determining, based on access information, to which of the storage tiers the actual areas allocated to the virtual volumes should be allocated,
wherein the allocation control part comprises
a determination part for determining a type of an application program that uses the actual area allocated to the virtual area from among the actual areas inside the pool, and
a reallocation destination instruction part for determining a reallocation destination of the actual area in accordance with the determination result by the determination part, and instructing the storage apparatus as to the determined reallocation destination.

2. A computer system management apparatus according to claim 1, further comprising:
a microprocessor;
a memory for storing a prescribed computer program that is executed by the microprocessor; and
a communication interface circuit for the microprocessor to communicate with the host computer and the storage apparatus,
wherein the allocation control part is realized by the microprocessor executing the prescribed computer program,
the determination part determines whether or not the type of the application program that uses the actual area is a first application program, which is a high-priority transaction process, and
the reallocation destination instruction part determines a reallocation destination for a first actual area such that the first actual area, which is used by the first application program from among the actual areas inside the pool, is preferentially allocated to a relatively high-performance storage tier of the storage tiers, and instructs the storage apparatus as to the determined reallocation destination.

3. A computer system management apparatus according to claim 2, wherein the determination part determines whether the type of the application program that uses the actual area is a first application program, which is a high-priority transaction process, or a second application program, which is a batch process that has a time limit,
the reallocation destination instruction part determines a reallocation destination of the first actual area such that the first actual area used by the first application program is preferentially allocated to the relatively high-performance storage tier,
determines a reallocation destination of a second actual area used by the second application program from among the actual areas inside the pool, and
instructs the storage apparatus as to the determined first actual storage area reallocation destination and the determined second actual storage area reallocation destination.

4. A computer system management apparatus according to claim 3, wherein the determination part acquires from a user, via a user interface part, application type information denoting whether the application programs running on the host computers are transaction processes or batch processes, and
acquires from the storage apparatus access information denoting an access frequency with which each of the application programs uses each of the actual areas.

5. A computer system management apparatus according to claim 4, wherein first access information, which denotes an access frequency with which the first application program uses the actual area, is acquired during a period of time that the second application program is executed.

6. A computer system management apparatus according to claim 5, wherein the allocation control part estimates a time required for the execution of the second application program,
compares the estimated time with the time limit configured in the second application program, and
notifies the user in a case where it has been determined that the estimated time fails to meet the time limit.

7. A computer system management apparatus according to claim 6, wherein, in a case where the estimated time with respect to the second application program meets the time limit, the allocation control part changes the allocation destination of the second actual area, which is allocated to the second application program, to a lower performance storage tier from among the storage tiers.

8. A computer system management apparatus according to claim 7, wherein the first access information is created based on an access frequency configured beforehand over multiple days.

9. A computer system management apparatus according to claim 8, wherein the allocation control part creates utilization status information denoting a situation under which the application programs use the actual areas of the storage tiers, and presents this information to the user.

10. A computer system management apparatus according to claim 9, wherein the allocation control part configures an access frequency range denoting a range of access frequencies allocated to the storage devices based on actual response performance of the storage device.

11. A computer system management apparatus according to claim 10, wherein the allocation control part estimates a time at which the first application program processing ends, and
starts the second application program processing after the estimated first application program processing end time.

12. A computer system management apparatus according to claim 11, wherein the allocation control part preferentially allocates the second actual area used by the second application program to a pre-specified storage tier from among the storage tiers.

13. A management method for managing a computer system, which comprises multiple host computers that run application programs and a storage apparatus that provides a virtual volume to the host computers,
wherein the storage apparatus comprises multiple pools comprising multiple storage tiers of respectively different performance, and
is configured so as to select an actual area from each of the storage tiers in accordance with a write access from each of the host computers, and to allocate this selected actual area to an access-target virtual area inside the write-accessed virtual volume of the respective virtual volumes,
the computer system management method comprising:
acquiring application definition information denoting whether a type of an application program that uses the actual area is a first application program, which is a high-priority transaction process, or a second application program, which is a time-limited batch process;
acquiring information related to accesses by the application programs to the actual areas allocated to the virtual areas of the virtual volumes;
determining, based on the access information, to which of the storage tiers the actual areas allocated to the virtual volumes should be allocated;
allocating beforehand an actual area used by the first application program;
next allocating an actual area used by the second application program; and
lastly allocating an actual area used by the remaining application program from among the application programs.
